(19) United States
(12) Patent Application Publication
(10) Pub. No.: US 2024/0035703 A1
(43) Pub. Date: Feb. 1, 2024

(54) FAN FILTER ASSEMBLY

(71) Applicant: Johnson Controls Tyco IP Holdings LLP, Milwaukee, WI (US)

(72) Inventors: Sushilkumar Dnyandev Gorad, Pune (IN); Abhijeet Rajesh Salunkke, Pune (IN); Rohan Kailas More, Gulbarga (IN); Christian Herbeck, Largo, FL (US); Timothy J. Wilson, Dacula, GA (US)

(21) Appl. No.: 18/226,705

(22) Filed: Jul. 26, 2023

(30) Foreign Application Priority Data
Jul. 28, 2022 (IN) 202221043184

(51) Int. Cl. F24F 13/28; F24F 8/108; F24F 7/06; B01D 46/00; B01D 46/62; B01D 46/10

(52) U.S. Cl. CPC F24F 13/28; F24F 8/108; F24F 7/065; B01D 46/0043; B01D 46/62; B01D 46/10; B01D 46/0002; B01D 2273/30; B01D 2279/50; B01D 2265/028

(57) ABSTRACT

A heating, ventilation, and air conditioning (HVAC) system includes a fan filter assembly to filter an air flow directed through the fan filter assembly and to a conditioned space. The fan filter assembly includes a fan to circulate the air flow through fan filter assembly and a filter to filter the air flow. The fan and the filter may be coupled to the fan filter assembly such that the fan and/or the filter may be easily accessed for maintenance activity, such as removal, inspection, replacement, and/or cleaning of the fan. The fan filter assembly may increase efficiency of the HVAC system by decreasing downtime of the fan filter assembly and decreasing cost associated with installation and/or maintenance activity. Therefore, the fan filter assembly may enable the HVAC system to improve air quality of the air flow provided to the conditioned space while also improving serviceability of the fan filter assembly.

### CROSS-REFERENCE TO RELATED APPLICATIONS

This application claims priority from and the benefit of Indian Provisional Application No. 202221043184, entitled “A FAN FILTER UNIT,” filed Jul. 28, 2022, which is hereby incorporated by reference in its entirety for all purposes.

### BACKGROUND

This section is intended to introduce the reader to various aspects of art that may be related to the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Heating, ventilation, and/or air conditioning (HVAC) systems are utilized in residential, commercial, and industrial applications to control environmental properties, such as temperature, humidity, and/or air quality, of respective indoor environments and/or spaces. The HVAC system may control the environmental properties through control of properties of an air flow delivered to and ventilated from spaces serviced by the HVAC system. In particular, the HVAC system may transfer heat between the air flow and a working fluid (e.g., refrigerant) flowing through the system (e.g., via a heat exchanger) to provide cooled air for an indoor environment. Similarly, the HVAC system may heat the air flow to provide warmth to the indoor environment. In some instances, the HVAC system may be used to filter the air flow provided to the indoor environment to control a quality of the air flow.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a fan filter assembly includes a main housing comprising a first opening and a second opening, a fan configured be disposed within and removably coupled to the main housing, a first filter housing configured to couple to the main housing adjacent to the first opening, wherein the first filter housing is configured to support a first filter, and a second filter housing configured to removably couple to the main housing adjacent to the second opening, wherein the second filter housing is configured to support a second filter, wherein the second filter housing is removable from the main housing to enable access to the fan via the second opening.

In another embodiment, a heating, ventilation, and air conditioning (HVAC) system includes a fan filter unit configured to filter an air flow directed through the fan filter unit. The fan filter unit includes a housing comprising a first opening, an internal volume, and a second opening, and a fan disposed within the internal volume and configured to direct the air flow through the housing, wherein the fan is removable from the housing via the second opening. The fan filter unit further includes a filter rack assembly configured to removably mount to an exterior of the housing, wherein the filter rack assembly is configured to contain a filter, and the fan is configured to discharge the air flow from the housing via the second opening and to direct the air flow through filter.

In another embodiment, a fan filter unit of a heating, ventilation, and air conditioning (HVAC) system includes a fan housing configured to receive an air flow, wherein the fan housing defines a first opening and a second opening, and the fan housing comprises a plurality of support member. The fan filter unit further includes a fan disposed within the fan housing and removably mounted to the fan housing via the plurality of support members, wherein the fan is configured to draw an air flow into the fan housing via the first opening and to discharge the air flow from the fan housing via the second opening. Moreover, the fan filter unit includes a filter housing removably coupled to the fan housing adjacent to the second opening, wherein the filter housing is removable from the fan housing to expose the fan via the second opening of the housing in an installed configuration of the fan filter unit, and a filter disposed within the filter housing and configured to filter the air flow discharged from the fan housing via the second opening.

### BRIEF DESCRIPTION OF THE DRAWINGS

Various aspects of the present disclosure may be better understood upon reading the following detailed description and upon reference to the drawings, in which:

FIG. 1 is a schematic diagram of an embodiment of an HVAC system including a fan filter assembly, in accordance with an aspect of the present disclosure;

FIG. 2 is a block diagram of an embodiment of a controller of an HVAC system, in accordance with an aspect of the present disclosure;

FIG. 3 is a perspective view of an embodiment of a fan filter assembly of an HVAC system, in accordance with an aspect of the present disclosure;

FIG. 4 is a perspective view of an embodiment of a fan filter assembly of an HVAC system, in accordance with an aspect of the present disclosure;

FIG. 5 is a partially exploded perspective view of an embodiment of a filter frame assembly of a fan filter assembly of an HVAC system, in accordance with an aspect of the present disclosure;

FIG. 6 is an exploded perspective view of an embodiment of a fan housing assembly of a fan filter assembly of an HVAC system, in accordance with an aspect of the present disclosure;

FIG. 7 is a partially exploded perspective view of an embodiment of a filter compartment of a fan filter assembly of an HVAC system, in accordance with an aspect of the present disclosure;

FIG. 8 is an exploded perspective view of an embodiment of a latch assembly of a fan filter assembly of an HVAC system, in accordance with an aspect of the present disclosure;

FIG. 9 is a perspective view of an embodiment of a latch assembly of a fan filter assembly in a retention position, in accordance with an aspect of the present disclosure;

FIG. 10 is a perspective view of an embodiment of a latch assembly of a fan filter assembly in a released position, in accordance with an aspect of the present disclosure;

FIG. 11 is an exploded perspective view of an embodiment of a fan filter assembly of an HVAC system, in accordance with an aspect of the present disclosure; and

FIG. 12 is a partially exploded perspective view of an embodiment of a fan filter assembly of an HVAC system, in accordance with an aspect of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “approximately,” “generally,” “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to convey that the property value may be within +/−5%, within +/−4%, within +/−3%, within +/−2%, within +/−1%, or even closer, of the given value. Similarly, when a given feature is described as being “substantially parallel” or “generally parallel” to another feature, “generally cross-wise” to another feature, and so forth, this is intended to convey that the given feature is within +/−5%, within +/−4%, within +/−3%, within +/−2%, within +/−1%, or even closer, to having the described nature, such as being parallel to another feature, being perpendicular or cross-wise to another feature, and so forth. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel.

As briefly discussed above, a heating, ventilation, and/or air conditioning (HVAC) system may be used in residential, commercial, and industrial applications to control environmental properties, such as temperature, humidity, and/or air quality, of respective indoor environments and/or spaces. The HVAC system may control the environmental properties through control of properties of an air flow delivered to and/or recirculated (e.g., ventilated) from spaces serviced by the HVAC system. In other words, the HVAC system may condition an air flow and/or air of a conditioned space, such as an indoor environment. For example, the HVAC system may transfer heat between the air flow and a working fluid (e.g., refrigerant) flowing through the system (e.g., via a heat exchanger) to provide cooled air for an indoor environment. Similarly, the HVAC system may heat the air flow to provide warmth to the indoor environment. In some embodiments, the HVAC system may include components to filter (e.g., purify, clean) the air flow provided to the indoor environment to control an air quality of the air flow. In addition, the components may also improve air circulation of the air flow within the indoor environment. Increasing the air quality and/or improving air circulation of the air flow may be beneficial in many applications, such as hospitals, laboratories, manufacturing, and/or any other environment in which filtered air is desired.

Conventional HVAC systems may utilize a filtering component in combination with a fan component to increase quality of an air flow and/or improve air circulation of the air flow provided to an indoor environment. In conventional designs, the fan component may be directly coupled, via a weld, to a housing. In addition, the filtering component may be located within the housing. Furthermore, the fan and/or filtering components may be routinely accessed and/or removed from the housing, such as for maintenance activity and/or repair. However, accessing and/or removing the fan and/or filtering component from the housing may be a strenuous and time consuming process due to configurations of conventional designs.

For example, accessing and/or removing the filtering component from the housing may involve disassembling all or a portion of the housing. Moreover, removing the fan component from the housing may involve cutting and/or breaking a weld (e.g., via plasma cutting, torch cutting, grinding via circular saws, etc.). In addition, following removal of the fan and/or filtering components, the fan and/or filtering component may be re-installed and/or re-welded to the housing. Thus, conventional designs including fan and/or filtering components may be inefficient as maintenance and/or repair activities may increase a cost (e.g., a total cost over a life of the fan and/or filtering components) of the fan and/or filtering components. Additionally, accessing, removing, and/or replacing the fan and/or filtering components may increase a downtime of the fan and/or filtering component, and thus increase a downtime and decrease efficiency of the HVAC system.

Accordingly, present embodiments are directed to an HVAC system including a fan filter assembly (e.g., fan filter unit). As further discussed herein, the fan filter assembly may be configured to operate independently of, be retrofitted to, and/or be integrated with components of the HVAC system. In addition, the fan filter assembly includes a filter (e.g., filter assembly) configured to filter an air flow directed through the fan filter assembly. Design of the fan filter assembly may enable the filter to be readily accessed for maintenance activity, such as removal, inspection, replacement, and/or cleaning of the filter. Furthermore, the fan filter assembly includes a fan (e.g., fan assembly) configured to circulate the air flow through fan filter assembly. Due to the design of the fan filter assembly, the fan may be readily accessible within a housing of the fan filter assembly. In particular, the fan is configured to couple to the housing such that the fan may be readily removed from the housing and/or reinstalled (e.g., replaced). As such, present embodiments of the fan filter assembly may enable the HVAC system to filter (e.g., purify, clean) an air flow provided to the indoor environment to control an air quality of the air flow while improving serviceability of the fan filter assembly. The fan filter assembly may also improve air circulation of the air flow within the indoor environment, as well as filtration of recirculated air within the indoor environment. In addition, a design (e.g., configuration) of the fan filter assembly may decrease a downtime of the HVAC system (e.g., the fan filter assembly) and decrease a cost associated with installation and/or maintenance activity of the fan filter assembly, thus increasing efficiency of the HVAC system.

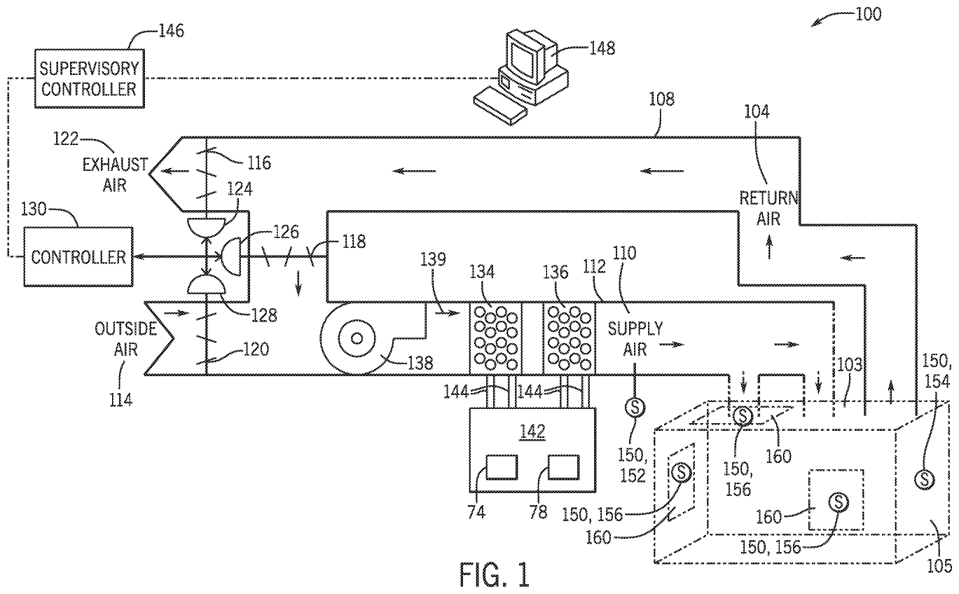

Turning now to the drawings, FIG. 1 is a schematic diagram of an embodiment of an HVAC system 100 including a fan filter assembly 160 (e.g., fan filter unit), in accordance with an aspect of the present disclosure. The HVAC system 100 may be configured to heat or cool an airflow provided to a conditioned space (e.g., indoor environment, building). As illustrated, the HVAC system 100 may be configured to vary the amount of outside air and return air used by the HVAC system 100 for producing a heated and/or cooled supply air. For example, the HVAC system 100 may receive return air 104 from conditioned space 105 via return air duct 108 and may deliver supply air 110 to conditioned space 105 via supply air duct 112. In some embodiments, the HVAC system 100 may include a rooftop unit located on a roof of a building or otherwise be positioned to receive both return air 104 and a supply of outside air 114. The HVAC system 100 may be configured to operate an exhaust air damper 116, a mixing damper 118, and an outside air damper 120 to control an amount of the outside air 114 and the return air 104 that combine to form the supply air 110. A portion of the return air 104 that does not pass through the mixing damper 118 may be discharged as exhaust air 122. For example, the portion of return air 104 that does not to cross the mixing damper 118 may be discharged to an outside environment (e.g., through the exhaust damper 116 as the exhaust air 122).

Each of dampers 116, 118, 120 may be operated (e.g., actuated) by an actuator. For example, as illustrated, the exhaust air damper 116 is actuated by a first actuator 124, the mixing damper 118 is actuated by a second actuator 126, and the outside air damper 120 can be operated by a third actuator 128. The first, second, and third actuators 124, 126, 128 may be communicatively coupled to a controller 130 (e.g., control system, CVM controller). For example, the first, second, and third actuators 124, 126, 128 may receive control signals from the controller 130. In addition, in some embodiments, the first, second, and third actuators 124, 126, 128 may transmit signals (e.g., feedback signals) to the controller 130. The feedback signals may include, for example, an indication of a current actuator or damper position, an amount of torque or force exerted by the actuator, diagnostic information (e.g., results of diagnostic tests performed by the first, second, and third actuators 124, 126, 128), status information, commissioning information, configuration settings, calibration data, and/or other types of information or data that can be collected, stored, or used by the first, second, and third actuators 124, 126, 128. The controller 130 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control the first, second, and third actuators 124, 126, 128.

The HVAC system 100 may include one or more heat exchangers configured to place the working fluid (e.g., the refrigerant) in a heat exchange relationship with a respective air flow passing through and/or across the heat exchanger. As illustrated, the HVAC system 100 is shown to include a first heat exchanger 134 (e.g., an evaporator, a cooling coil) and a second heat exchanger 136 (e.g., a condenser, a heating coil) positioned within supply air duct 112. In particular, tubes (e.g., coils) of the respective first and second heat exchanger 134, 136 may be fluidly coupled to a vapor compression system 142 (e.g., HVAC unit) via piping 144. The vapor compression system 142 may additionally include a compressor 74 and one or more valves 78 (e.g., an expansion valve 78). Furthermore, the vapor compression system 142 may circulate a heat transfer fluid (e.g., glycol, R-1234ze, R-1233zd, ammonia, carbon dioxide, steam, or water) through the first and second heat exchangers 134, 136. The tubes may be of various types, such as multichannel tubes, copper or aluminum tubing, and so forth. Additionally, the tubes may be in various configurations within the first and second heat exchanger 134, 136. For example, in some embodiments, each of the heat exchangers 216, 224 may include a plurality of heat transfer fluid tubes defining a plurality of heat transfer fluid flow paths extending through the first and second heat exchanger 134, 136 and in parallel with one another. In some embodiments, the plurality of heat transfer fluid tubes may have a plurality of fins extending from the respective heat transfer fluid tubes to increase the surface area, and thus, the heat exchange area of the plurality of heat transfer fluid tubes of first and second heat exchanger 134, 136. Together, the first and second heat exchanger 134, 136 may implement a thermal cycle in which the heat transfer fluid undergoes phase changes and/or temperature changes as it flows through first and second heat exchanger 134, 136 to reject or absorb thermal energy and, thus, produce heated and/or cooled air (e.g., the supply air 110).

In addition, the HVAC system 100 is shown to include a fan 138 positioned within supply air duct 112. In some embodiments, the fan 138 may be configured to force an air flow through the first heat exchanger 134 and/or the second heat exchanger 136 to produce the supply air 110 to the conditioned space 105. Alternatively, the fan 138 may be a draw-through fan, and thus may be positioned down-stream of the first and second heat exchangers 134, 136 with respect to a direction 139 of the air flow through the supply air duct 112. In this way, the fan 138 may be configured to draw an airflow through the first heat exchanger 234 and/or the second heat exchanger 136 to produce the supply air 110 to the conditioned space 105. The controller 130 may be communicatively coupled to the fan 138 to control a flow rate of an air flow through the supply air duct 112. In some embodiments, the controller 130 may be configured to control an amount of heating or cooling applied to the air flow through the supply air duct 112 by modulating (e.g., adjusting) a speed of the fan 138. As further discussed herein, the controller 130 may additionally be configured to control one or more components of the HVAC system 100 and/or the vapor compression system 142 to enable heating, cooling, and/or filtering of an air flow supply (e.g., producing the supply air 110) to meet a target air temperature and/or air quality of the conditioned space 105.

Moreover, the HVAC system 100 includes the fan filter assembly 160 (e.g., fan filter unit) configured to filter (e.g., purify, clean) an air flow provided to the conditioned space 105. In particular, in some embodiments, the fan filter assembly 160 may be configured to control (e.g., adjust) a quality of air within the conditioned space 105. As illustrated, the fan filter assembly 160 may be located (e.g., positioned, installed) at least partially within the conditioned space 105. As illustrated, the fan filter assembly 160 may be positioned (e.g., installed) at any suitable location within the conditioned space 105. For example, the fan filter assembly 160 may be positioned (e.g., installed, mounted) at least partially within a ceiling 103 of the conditioned space 105, a wall of the conditioned space 105, and/or be position on or coupled to a floor of the conditioned space 105.

In some embodiments, the fan filter assembly 160 may be positioned within the conditioned space 105 such that the fan filter assembly 160 receives the supply air 110 from the supply air duct 112 (e.g., at least a portion of the supply air 110). For example, the fan filter assembly 160 may be installed at an end of the supply air duct 112 to receive the supply air 110 from the HVAC system 100 before the supply air 110 is provided to the conditioned space 105. Alternatively, the fan filter assembly 160 may be located separately from the HVAC system 100. For example, the fan filter assembly 160 may be installed within the conditioned space 105, but separate from the supply air duct 112, such that the fan filter assembly 160 filters an air flow from the conditioned space 105 that is separate from the supply air 110. For example, the fan filter assembly 160 may be configured to recirculate and filter air within the conditioned space 105. As further discussed herein, in some embodiments, the controller 130 may be communicatively coupled to the fan filter assembly 160 to control a flow rate of an air flow through the fan filter assembly 160 (e.g., via a fan). Alternatively, in some embodiments, the fan filter assembly may include a separate controller (e.g., control system) configured to control a flow rate of an air flow through the fan filter assembly 160.

The HVAC system 100 may also include a supervisory controller 146 and a client device 148. The supervisory controller 146 may include one or more computer systems (e.g., servers, supervisory controllers, subsystem controllers, etc.) that serve as system level controllers, application or data servers, head nodes, or master controllers for the HVAC system 100. The supervisory controller 146 may be communicatively coupled to and configured to communicate with and/or control operations of multiple downstream building systems or subsystems (e.g., HVAC system 100, a security system, a lighting system, etc.). As discussed in more detail below, the supervisory controller 146 may communicate via one or more signals according to a communication protocol (e.g., LON, BACnet, etc.). The one or more signals may be transmitted through wired or wireless communications interfaces (e.g., jacks, antennas, transmitters, receivers, transceivers, wire terminals, etc.) and/or may be direct (e.g., local wired or wireless communications) or via a communications network (e.g., a WAN, the Internet, a cellular network, etc.). In some embodiments, the controller 130 and the supervisory controller 146 may be separate (as shown in FIG. 1) or integrated. In an integrated implementation, the controller 130 may be a software module configured for execution by a processor of the supervisory controller 146.

In some embodiments, the controller 130 receives information from the supervisory controller 146 (e.g., commands, setpoints, operating boundaries, etc.) and provides information to supervisory controller 146 (e.g., temperature, humidity, and/or air quality measurements, valve or actuator positions, operating statuses, diagnostics, etc.). In particular, the controller 130 may be communicatively coupled to one or more sensors 150 disposed within the HVAC system 100. For example, as illustrated, a first sensor 152 may be disposed within the supply air duct 112 and configured to detect a first temperature, a first humidity, and/or a first air quality of the supply air 110 within the supply air duct 112. Additionally, a second sensor 154 may be disposed within the conditioned space 105 (e.g., conditioned space) and configured to detect a second temperature, a second humidity, and/or second air quality of ambient air within the conditioned space 105. In some embodiments, the HVAC system 100 may include an additional sensor 156 (e.g., filter differential pressure sensor) associated with the fan filter assembly 160. The additional sensor 156 may be configured to monitor a condition of a filter within the fan filter assembly 160. For example, the additional sensor 156 may output signals indicating a relative drop (e.g., decrease) in pressure and/or air flow rate across a filter of the fan filter assembly 160. The drop in pressure may indicate replacement and/or cleaning of the filter to improve operations of the fan filter assembly 160. The one or more sensors 150 may output signals including detected temperature, humidity, pressure, and/or air quality measurements to the controller 130. Furthermore, the controller 130 may provide the supervisory controller 146 with temperature, humidity, and/or air quality measurements from the one or more sensors 150 to enable the supervisory controller 146 to monitor and/or adjust (e.g., via the controller 130) the temperature, humidity, pressures, and/or air quality of the air within the conditioned space 105.

In some embodiments, the controller 130 may provide the supervisory controller 146 with information associated with components of the HVAC system 100 (e.g., dampers, blowers, the one or more components of the HVAC system 100, etc.) such as, for example, equipment on/off states, equipment operating capacities, and/or any other information that may be used by the supervisory controller 146 to monitor and/or control temperature, humidity, and/or air quality within the conditioned space 105. In some embodiments and as discussed in more detail below, the supervisory controller 146 and/or the controller 130 may receive input from the one or more sensors 150 located within the HVAC system 100 and/or within the conditioned space 105 and may adjust a flow rate and/or a flow direction of the refrigerant within the vapor compression system 142, thus adjust a temperature of the supply air 110, adjust an air flow rate (e.g., via the blower 138, the one or more dampers 116, 118, 120, etc.), or other attributes of the supply air 110 produced by the HVAC system 100, based on the input from the one or more sensors 150, to achieve target setpoint conditions (e.g., temperature, humidity, and/or air quality) for the conditioned space 105.

Furthermore, the client device 148 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. The client device 148 may be a computer workstation, a client terminal, a remote device, a remote or local interface, or any other type of user interface device. In some embodiments, the client device 148 may be a stationary terminal or a mobile device. For example, client device 148 can be a desktop computer, a computer server with a user interface, a laptop computer, a tablet, a smartphone, a PDA, or any other type of mobile or non-mobile device. In the illustrated embodiment, the client device 148 is communicatively coupled to the supervisory controller 146 and the controller 310 (e.g., via the supervisory controller 146). The client device 148 may be configured to transmit signals (e.g., control signals) and/or receive signals (e.g., feedback signals) from the supervisory controller 146 and/or the controller 130 to enable the client device 148 to monitor and/or control the temperature, humidity, and/or air quality within the conditioned space 105.

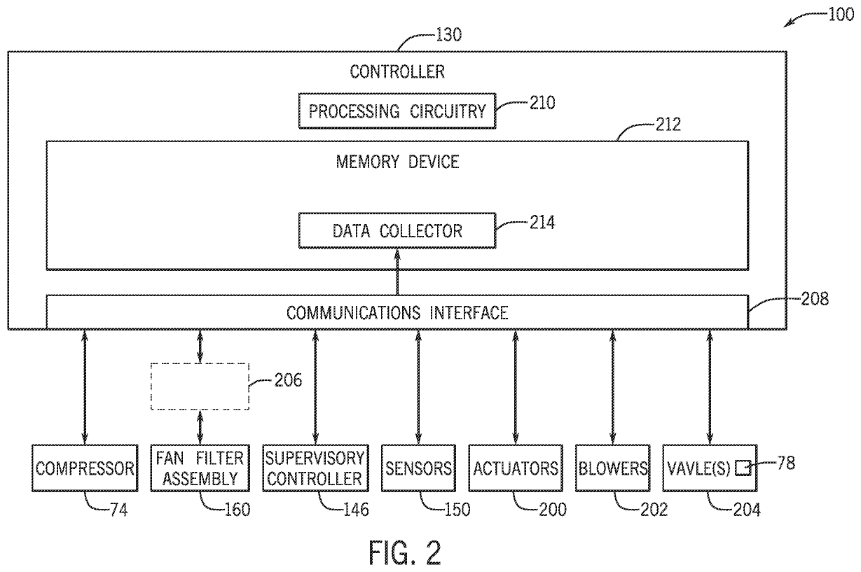

With the foregoing in mind, FIG. 2 is a block diagram of an embodiment of the controller 130 (e.g., control system) of the HVAC system 100, in accordance with an aspect of the present disclosure. The controller 130 may be configured to monitor and control various components of HVAC system 100 using any of a variety of control techniques (e.g., state-based control, on/off control, proportional control, proportional-integral (PI) control, proportional-integral-derivative (PID) control, extremum seeking control (ESC), model predictive control (MPC), etc.). Furthermore, as discussed herein, the controller 130 may receive desired (e.g., target) temperature, humidity, and/or air quality setpoints from one or more of the control devices (e.g., the control device 16, thermostat) and/or the supervisory controller 146, as well as temperature, humidity, and/or air quality measurements from the one or more sensors 150, including, for example, the first and/or second sensors 152, 154. Based on the data and/or feedback received, the controller 130 may provide (e.g., output) control signals to the various components of the HVAC system 100 including the actuators 200 (e.g., the first, second, and third actuators 124, 126, 128), blowers 202 (e.g., the blower 138), one or more valves 204 (e.g., the expansion valve 78), the compressor 74, and so forth, to dynamically adjust an air flow rate and/or a refrigerant flow rate within the HVAC system 100 and/or the vapor compression system 142 to enable efficient satisfaction of the desired temperature, humidity, and/or air quality setpoints.

The one or more sensors 150 communicatively coupled to the controller 130 may include the first and second sensors 152, 154 illustrated in FIG. 1 and/or any other sensor configured to monitor various operating conditions of the HVAC system 100, the conditioned space 105 (e.g., conditioned space), a surrounding environment of the building 10, or any combination thereof. The one or more sensors 150 may additionally or alternatively monitor various operational states of components of the HVAC system 100. In some embodiments, the various conditions may include, for example, conditioning zone air temperature, conditioning zone air humidity, conditioning zone air quality, conditioning zone occupancy, conditioning zone CO2 levels, conditioning zone particulate matter (PM) levels, outdoor air temperature, outdoor air humidity, outdoor air CO2 levels, outdoor air PM levels, damper positions, valve positions, blower status, supply air temperature, supply air flow rate, refrigerant flow rate, compressor speed, expansion device status, or any combination thereof.

Furthermore, one or more actuators 200 may be communicatively coupled to the controller 130 and configured to adjust one or more of the components of the HVAC system 100. The one or more actuators 200 may receive control signals from the controller 130 and may be configured to adjust an operational state of the one or more components of the HVAC system 100 based on the control signals. For example, the one or more actuators 200 may include the first actuator 124 associated with and configured to operate the exhaust air damper 116, the second actuator 126 associated with and configured to operate the mixing damper 118, and the third actuator 128 associated with and configured to operate the outside air damper 120. The one or more actuators 200 may receive the control signals from the controller 130 and/or may provide feedback signals to the controller 130 indicative of an operational state of the component associated with the one or more actuator 200.

As discussed herein, the controller 130 may additionally be communicatively coupled to the vapor compression system 142 (e.g., the compressor 74, the one or more valves/expansion valve 78) and one or more blowers 202, and be configured to control an operational state of the vapor compression system 142 (e.g., a compressor 74, the one or more valves/the expansion valve 78) and the one or more blowers 202. In particular, the controller 130 may enable efficient operation (e.g., maintaining a desired temperature, humidity, and/or air quality setpoint of the conditioned space 105) of the HVAC system 100 by controllably adjusting components of the HVAC system 100 via outputting control signals to the actuators 200, the vapor compression system 142 (e.g., the compressor 74, the one or more valves/the expansion valve 78) and the one or more blowers 202, based on feedback signal received from the one or more sensors 150. In some embodiments, the control signals may include commands (e.g., instructions) for the one or more actuators 200 to set dampers (e.g., the outside air, exhaust air, mixing dampers 116, 118, 120), to specific operational positions to achieve an operational target value for an operational condition of the HVAC system 100 (e.g., supply air temperature, supply air humidity, air quality of supply air, relative proportions of the outside air and/or return air, refrigerant flow rate, refrigerant flow direction, etc.). In some embodiments, the control signals may include commands (e.g., instructions) for blowers 202 to operate a specific operating speed and/or to achieve a specific air flow rate. Moreover, in some embodiments, the control signals may include commands (e.g., instructions) for the compressor 74 of the vapor compression system 142 to operate at a specific operating speed and/or to achieve a specific refrigerant flow rate. As illustrated, the control signals may be provided to the one or more actuators 200, the blowers 202, the valves 204, and/or to the compressor 74 via a communications interface 208.

Furthermore, in some embodiments, the fan filter assembly 160 may be communicatively coupled to the controller 130. The controller 130 may be configured to adjust an operational state of the fan filter assembly 160. In particular, the controller 130 may be configured to adjust a speed of a fan of the fan filter assembly 160 to control a flow rate of an air flow through the fan filter assembly 160. The fan filter assembly 160 (e.g., the fan) may receive control signals from the controller 130 and may be configured to adjust a speed (e.g., rate of rotation) of the fan based on the control signals. In some embodiments, the fan filter assembly 160 may provide feedback signals to the controller 130 indicative of an operational state of the fan. As discussed herein, the fan filter assembly 160 may include a fan filter controller 206 (e.g., control system) configured to control (e.g., adjust) an operational state of the fan filter assembly 160 (e.g., fan). In such embodiments, the fan filter controller 206 may be separate from the controller 130. The fan filter controller 206 may be communicatively coupled to the controller 130. Alternatively, in some embodiments, the fan filter controller 206 may operate independently of the controller 130. In any embodiment, the controller 130 and/or the fan filter controller 206 may control operation of the fan filter assembly 160 to achieve a target air quality of the air within the conditioned space 105.

Moreover, the controller 130 may receive various inputs via the communications interface 208. The inputs received by the controller 130 may include desired (e.g., target) temperature, humidity, and/or air quality setpoints from the supervisory controller 146, measurements from the one or more sensors 150, such as air temperature, humidity, air quality, a measured or observed position and/or operational status of the dampers 116, 118, 120, a measured or observed position and/or operational status of the expansion device 78, a measured or calculated amount of power consumption, a measured or observed blower speed, a measured or observed fan speed (e.g., of the fan filter assembly 160), data (e.g., setpoints) from control devices 16, refrigerant flow rate, refrigerant flow direction, refrigerant temperature and/or pressure, or any combination thereof. In some embodiments, the controller 130 may include control logic to determine the outputted control signals based on a target outcome (e.g., target operating parameter to be achieved). For example, the control logic implemented by the controller 130 may control the operations of the components of the HVAC system 100 based on a comparison between an operational state determined by the various inputs received from the one or more components of the HVAC system 100 and a received and/or stored desired operating condition setpoint, such as a desired setpoint temperature, humidity, and/or air quality. The desired operational setpoint may be received from a user input (e.g., via a thermostat), the supervisory controller 146, and/or another upstream device via a communications network (e.g., a BACnet network, a LonWorks network, a LAN, a WAN, the Internet, a cellular network, etc.).

Still referring to FIG. 2, as discussed herein, the controller 130 may include the communications interface 208 configured to facilitate transmission of output control signals to the components of the HVAC system 100 and/or reception of input signals indicative of measurements of the operating conditions of the components and/or of desired operational setpoints of the HVAC system 100. The communications interface 208 may include wired or wireless communications interfaces (e.g., jacks, antennas, transmitters, receivers, transceivers, wire terminals, etc.) for conducting data communications with various components of the HVAC system 100 or other external systems or devices. In some embodiments, communications via the communications interface 208 may be direct (e.g., local wired or wireless communications) or via a communications network (e.g., a WAN, the Internet, a cellular network, etc.). For example, the communications interface 208 may include an Ethernet card and port for sending and receiving data via an Ethernet-based communications link or network. In another example, the communications interface 208 may include a Wi-Fi transceiver for communicating via a wireless communications network. In another example, the communications interface 208 may include a cellular or mobile phone transceiver, a power line communications interface, an Ethernet interface, or any other type of communications interface.

In some embodiments, the controller 130 may include processing circuitry 210 (e.g., system of processors) and a memory device 212. The processing circuitry 210 may be one or more general purpose or specific purpose processors, an application specific integrated circuit (ASIC), one or more field programmable gate arrays (FPGAs), a group of processing components, or other suitable processing components. The processing circuitry 210 may be configured to execute computer code or instructions stored in the memory device 212 and/or received from other computer readable media (e.g., CDROM, network storage, a remote server, etc.).

The memory device 212 may include one or more devices (e.g., memory units, memory devices, storage devices, etc.) for storing data and/or computer code for completing and/or facilitating the various processes and/or techniques described herein. The memory device 212 may include random access memory (RAM), read-only memory (ROM), hard drive storage, temporary storage, non-volatile memory, flash memory, optical memory, or any other suitable memory for storing software objects and/or computer instructions. The memory device 212 may include database components, object code components, script components, or any other type of information structure for supporting the various activities and information structures described in the present disclosure. Furthermore, the memory device 212 may be communicably connected to processing circuitry 210 and may include computer code for executing (e.g., by the processing circuitry 210) one or more processes and/or techniques described herein.

In some embodiments, the memory device 212 may include one or more functional components (e.g., stored instructions or programs) that enable the controller 130 to monitor and control the components of the HVAC system 100, as described herein. For example, in the illustrated embodiment, the memory device 212 is shown to include a data collector 214 which operates to collect data via the various input signals received by the communications interface 208 (e.g., desired operational setpoints, temperature, humidity, air quality, and/or pressure measurements, feedback from the one or more actuators 200, the blowers 202, the valves 204, the compressor 74, the fan filter assembly 160, etc.). The data collector 214 may receive, analyze, compare, and/or interpret the collected data for the controller 130. The controller 130 may then generate control signals based on the collected data to output to and adjust the components of the HVAC system 100. The particular type of control methodology used by the controller 130 (e.g., state-based control, PI control, PID control, ESC, MPC, etc.) may vary depending on the configuration of the controller 130 and may be adapted for various implementations.

In some embodiments, the controller 130 may include a primary controller configured to perform some or all of the functions and operations described herein. In other embodiments, the controller 130 (e.g., control system) may include one or more controllers in addition to the primary controller. For example, the controller 130 may be a centralized control system of the HVAC system 100 that includes the primary controller and one or more additional controllers (e.g., dedicated controllers), such as an actuator controller, a compressor controller, a blower controller, and a valve controller that are each configured to control a respective or corresponding component of the HVAC system 100. In addition, in some embodiments, the one or more additional controllers may include the fan filter controller 206 configured to control operation of the fan filter assembly 160. As discussed herein, the fan filter controller 206 may be communicatively coupled to the controller 130 (e.g., the primary controller). In alternative embodiments, the fan filter controller 206 may be separate from and/or not communicatively coupled to the controller 130 (e.g., the primary controller).

In some embodiments, the one or more additional controllers may be communicatively coupled to the primary controller and may be configured to send data and/or control signals to the primary controller, receive and/or control signals from the primary controller. Additionally or alternatively, the one or more additional controllers may receive data from any of the sensors described herein and/or may send or receive data to another controller of the HVAC system 100, such as the supervisory controller 146.

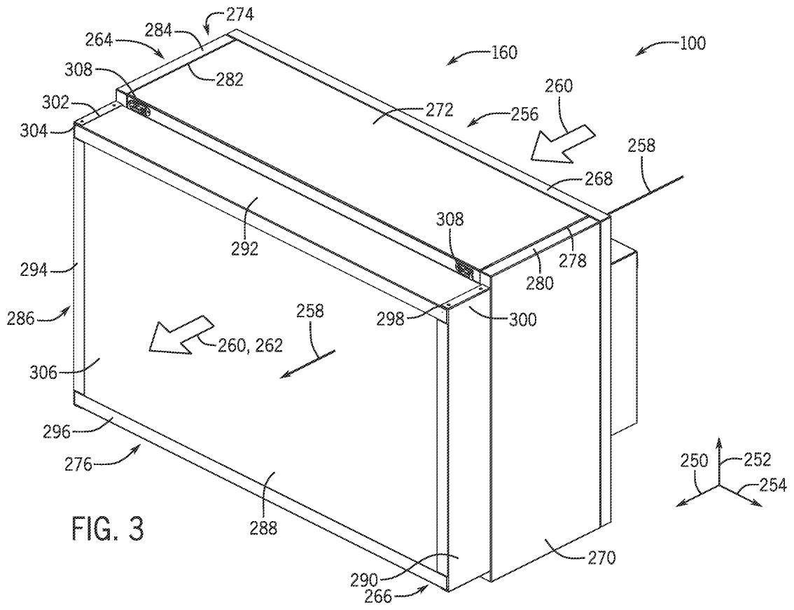

With the foregoing in mind, FIG. 3 is a perspective view of an embodiment of the fan filter assembly 160 that may be used in any suitable HVAC system 100. In particular, the fan filter assembly 160 may be configured to operate independently of, be retrofitted to, or be integrated with components of any suitable HVAC system. For example, the fan filter assembly 160 may be installed at a terminal end of the ductwork 112 or receive supply air 110. In such instances, the fan filter assembly 160 is configured to receive an air flow from the HVAC system 100 (e.g., via the ductwork 112), and filter the air flow prior to the air flow being supplied to the building 10, the residence 52, and/or the conditioned space 105. In some embodiments, the fan filter assembly 160 may be installed separately from components (e.g., the ductwork 14, 68, 112) of the HVAC system 100, and thus be configured to intake, filter, and/or re-supply (e.g., re-circulate) an air flow (e.g., indoor air flow) from an indoor environment (e.g., of the conditioned space 105). In such embodiments, the fan filter assembly 160 may operate as a ductless fan filter assembly. The fan filter assembly 160 may be installed at least partially within a ceiling (e.g., drop-ceiling, flush with ceiling, suspended from a ceiling) and/or a wall of an indoor environment. In some embodiments, the fan filter assembly 160 may be free-standing. To facilitate discussion, the fan filter assembly 160 and its respective components may be described with reference to a longitudinal axis 250, a vertical axis 252, which is oriented relative to a direction of gravity, and a lateral axis 254.

In the illustrated embodiment, the fan filter assembly 160 includes a housing 256 (e.g., housing assembly) configured to contain (e.g., house, enclose, partially enclose, hold, surround, support) a fan and/or filtering components of the fan filter assembly 160. In addition, the housing 256 defines an air flow path 258 therethrough. An air flow 260 may enter the housing 256 as a pre-conditioned air flow, a return air flow, an ambient air flow, any combination thereof, or another suitable air flow. Further, the air flow 260 may be discharged from the fan filter assembly 160 as a filtered air flow 260, 262 and may be directed toward a conditioned space. In addition, the housing 256 may include a fan housing 264 (e.g., main housing) coupled to a filter rack assembly 266 (e.g., filter compartment). The fan housing 264 includes a main panel 268 and plurality of side panels. In particular, as illustrated, the fan housing 264 may include a first side panel 270, a second side panel 272, a third side panel 274, and a fourth side panel 276. Each of the side panels 270, 272, 274, 276 extend cross-wise from the main panel 268 (with respect to a plane of the main panel 268). In addition, each of the side panels 270, 272, 274, 276 are coupled to two adjacent side panels. For example, the second side panel 272 is coupled to the first side panel 270 and the third side panel 274. In particular, a first edge 278 of the second side panel 272 is coupled to a first edge 280 of the first side panel 270, and a second edge 282 of the second side panel 272 is coupled to a first edge 284 of the third side panel 274. In addition, in the illustrated embodiment, the first and third side panels 270, 274 are generally parallel to each other, and the second and fourth side panels 272, 276 are generally parallel to each other. Moreover, the first and third side panels 270, 274 are approximately equal to each other in size and geometry (e.g., shape). The second and fourth side panels 272, 276 are approximately equal to each other in size and geometry (e.g., shape). However, the size and geometry of the second and fourth side panels 272, 276 are different from the size and geometry of the first and third side panels 270, 274. It should be appreciated, that any of the side panels and/or the main panel 268 (e.g., the first, second, third, fourth side panels 270, 272, 274, 276) of the fan filter assembly 160 may be of any suitable size and/or geometry (e.g., shape) so as to be coupled together to form a housing (e.g., fan housing 264).

In addition, in the illustrated embodiment, the second and fourth side panels 272, 276 may each extend along respective planes that are cross-wise to planes associated with the first and third side panels 270, 274. The main panel 268 and the side panels 270, 272, 274, 276 may define a space (e.g., area, chamber) within which one or more components (e.g., a fan) of the fan filter assembly 160 may be contained. In particular, the housing 256 (e.g., fan housing 264) may be configured to support, protect, and/or shield (e.g., provide a sound barrier) for the one or more components of the fan filter assembly 160.

The housing 256 also includes the filter rack assembly 266 (e.g., filter compartment) coupled to the fan housing 264. The filter rack assembly 266 may include a filter frame 286 (e.g., filter housing) and a filter 288 (e.g., fine particle filter, spun glass filter, fiberglass filter, pleated filter, high efficiency particulate air [HEPA] filter). Furthermore, the filter frame 286 is configured to hold (e.g., support, contain) the filter 288. In particular, the filter frame 286 is formed by a plurality of frame panels. As illustrated, the filter frame 286 includes a first frame panel 290, a second frame panel 292, a third frame panel 294, and a fourth frame panel 296. As further discussed herein, the filter rack assembly 266 may be coupled (e.g., removably mounted) to the fan housing 264, such that the filter rack assembly 266, and thus the filter 288, may be readily accessed. In addition, improved removal and/or detachment of the filter rack assembly 266 from the fan housing 264 may enable more efficient access to one or more other components of the fan filter assembly 160, such as a fan. In addition, each of the frame panels 290, 292, 294, 296 extends generally parallel to a respective side panel of the fan housing 264 and extends generally cross-wise to the main panel 268. In addition, each of the frame panels 290, 292, 294, 296 is coupled to two adjacent frame panels. For example, the second frame panel 292 is coupled to the first frame panel 290 and the third frame panel 294. In particular, a first edge 298 of the second frame panel 292 is coupled to a first edge 300 of the first frame panel 290, and a second edge 302 of the second frame panel 292 is coupled to a first edge 304 of the third frame panel 294. In addition, in the illustrated embodiment, the first and third frame panels 290, 294 are generally parallel to each other, and the second and fourth frame panels 292, 296 are generally parallel to each other. Moreover, the first and third frame panels 290, 294 are approximately equal to each other in size and geometry (e.g., shape). The second and fourth frame panels 292, 296 are approximately equal to each other in size and geometry (e.g., shape). However, the size and geometry of the second and fourth frame panels 292, 296 are different from the size and geometry of the first and third frame panels 290, 294. It should be appreciated, that any of the frame panels (e.g., the first, second, third, fourth frame panels 290, 292, 294, 296) of the fan filter assembly 160 may be of any suitable size and/or geometry (e.g., shape) so as to couple together to form a frame (e.g., filter frame 276) configured to support a filter (e.g., filter 288).

In addition, the second and fourth frame panels 292, 296 each extend along respective planes that are generally cross-wise to planes associated with the first and third frame panels 290, 294. The frame panels 290, 292, 294, 296 of the filter rack assembly 266 may be configured to support and/or contain the filter 288. In particular, the filter 288 may be configured to extend across and occupy an area (e.g., an entire area) of a discharge opening 306 (e.g., opening) of the fan filter assembly 160 (e.g., fan housing 264). Thus, the fan filter assembly 160 may be configured to efficiently filter (e.g., purify, clean, capture particles within) the air flow 260 directed through the fan filter assembly 160 (e.g., via the filter 288).

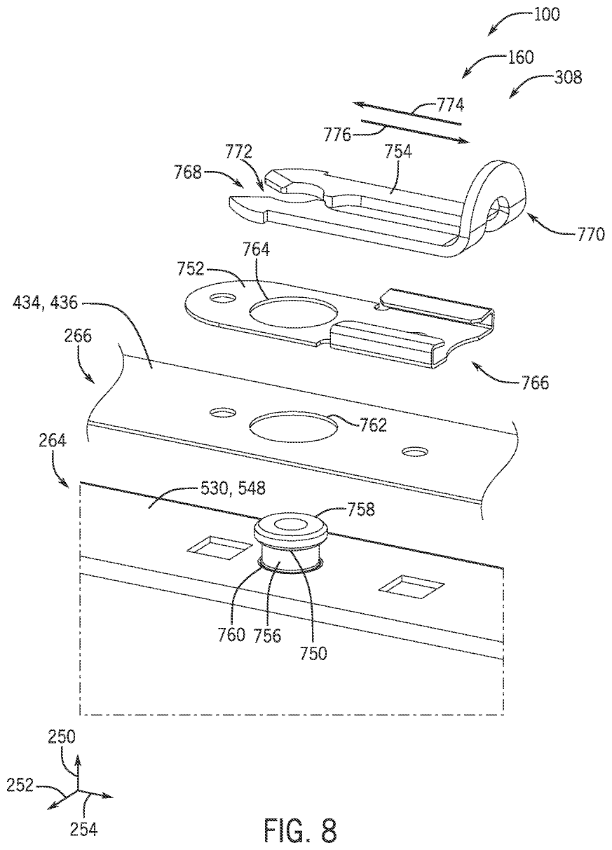

The fan filter assembly 160 may include one or more latch assemblies 308 configured to couple (e.g., removably couple, removably mount) the filter rack assembly 266 to the fan housing 264. In particular, the latch assemblies 308 may enable improved (e.g., more efficient) removal and reinstallation of the filter rack assembly 266 from the fan housing 264. As such, the filter rack assembly 266 may improve accessibility, and the filter 288 of the fan filter assembly 160 may be more efficiently removed from the filter rack assembly 266 and/or replaced (e.g., during cleaning and/or maintenance activities). In addition, as further discussed herein, removal of the filter rack assembly 266 may enable more efficient access to internal components of the fan filter assembly 160, such as a fan. The latch assemblies 308 are described in further detail below with reference to FIGS. 8-10.

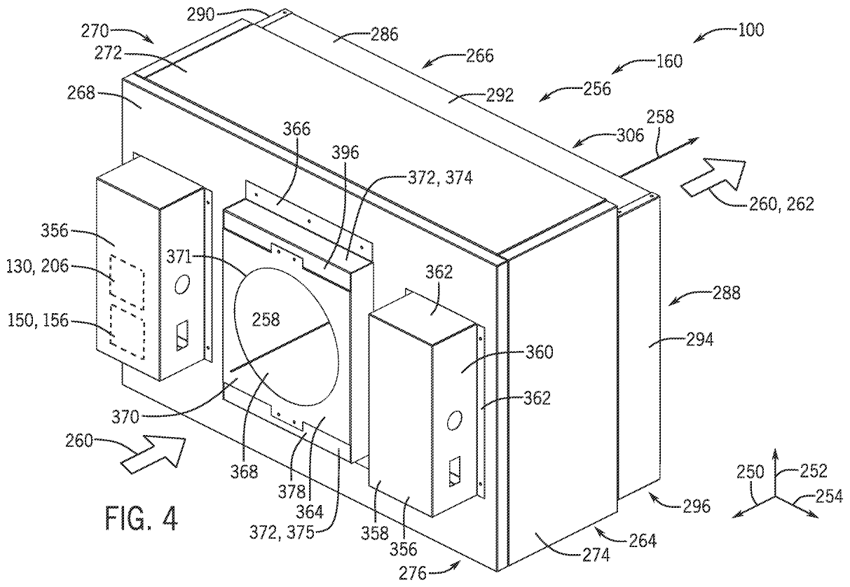

FIG. 4 is a perspective view of an embodiment of the fan filter assembly 160, in accordance with an aspect of the present disclosure. In particular, the fan filter assembly 160 of FIG. 4 is rotated approximately 180 degrees about the vertical axis 252 with respect to a position of the fan filter assembly 160 illustrated in FIG. 3. As such, FIG. 4 illustrates an embodiment of the main panel 268 and the respective components of the main panel 268. The fan filter assembly 160 of FIG. 4 includes similar components as those described with reference to FIG. 3. Furthermore, as illustrated, the fan filter assembly 160 may include one or more compartments 356 (e.g., housings, frames) coupled to (e.g., via one or more fasteners, bolts, screws, etc.) and extending from the main panel 268. In particular, each of the compartments 356 may include one or more flanges 360 extending generally parallel to the main panel 268 and configured to be coupled to the main panel 268. In addition, each of the compartments 356 may be configured to house (e.g., contain, protect, support) control and/or electrical components of the fan filter assembly 160. The control and/or electrical components may include, for example, the controller 130, a power supply, a power outlet/inlet, one or more sensors 150, circuitry, etc. Each of the compartments 356 may include a base panel 358 and four side panels 362 coupled to and extending from the base panel 358. In some embodiments, each of the compartments 356 (e.g., the base panel 358 and the four side panels 362) may be formed of a single piece. Alternatively, in some embodiments, the base panel 358 and each of the four side panels 362 may be separate components coupled to one another. In any case, the components of each compartment 356 may be formed from any suitable material, such as sheet metal, and may be formed via any suitable process, such as cutting, bending, welding, and so forth. In addition, each of the compartments 356 may be configured to define an internal space separate from an internal space (e.g., internal volume) of the fan housing 264. As such, the one or more compartments 356 (and any components housing therein), may not inhibit an air flow through the fan filter assembly 160 and/or decrease a volume available for the air flow within the fan filter assembly 160, and thus increase efficiency of the fan filter assembly 160. Furthermore, the one or more compartments 356 (and any components housing therein) may be easily accessed and/or serviced as the compartments 356 are coupled to an external surface of the main panel 268.

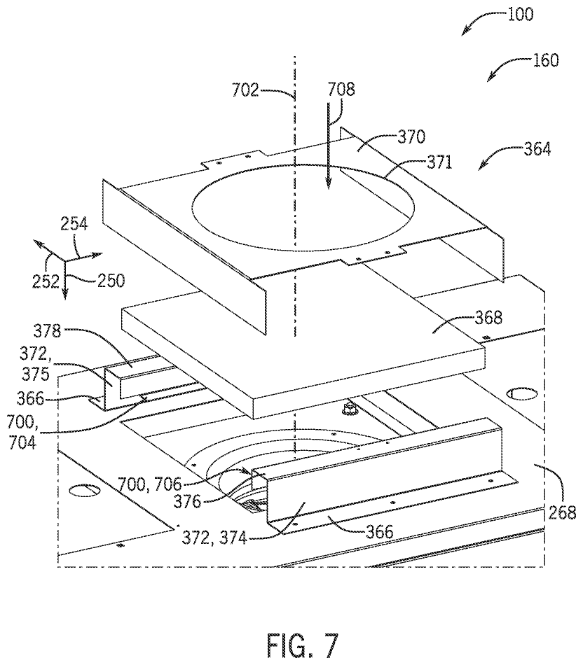

Moreover, the fan filter assembly 160 may include a filter compartment 364 (e.g., filter housing) coupled to (e.g., via one or more fasteners, bolts, screws, etc.) and extending from the main panel 268. In particular, the filter compartment 364 may include one or more flanges 366 extending generally parallel to the main panel 268 and configured to be coupled to the main panel 268. In addition, the filter compartment 364 may be configured to house a filter 368 (e.g., large particle filter, pre-filter, mesh filter, carbon filter). The filter 368 may be configured to remove (e.g., capture) relatively large particles and/or pollutants, such that the large particles and/or pollutants may be removed from the air flow 260 entering the fan filter assembly 160. The filter compartment 364 includes an inlet portion 370 and two side portions 372. In some embodiments, the filter compartment 364 (e.g., the inlet portion 370 and the two side portions 372) may be formed of a single piece. Alternatively, in some embodiments, the inlet portion 370 and each of the two side portions 372 may be separate components. For example, as illustrated, the two side portions 372 include a first side portion 374 and a second side portion 375. The inlet portion 370 may include an intake opening 371 (e.g., inlet, hole) configured to enable the air flow 352 to enter the filter compartment 364. In particular, the air flow 352 may traverse the filter 368 prior to entering the filter compartment 364. In addition, the inlet portion 370 is coupled to a first face 376 of the first side portion 374 and a second face 378 of the second side portion 375. As such, the inlet portion 370 may be easily removed from the filter compartment 364, for example, by decoupling the inlet portion 370 from the first and second side portion 374, 375. This may improve serviceability of the fan filter assembly 160 as the filter 368 may be easily accessed for maintenance activity (e.g., remove, inspect, replace, clean, etc.) In any case, the components of the filter compartment 364 may be formed from any suitable material, such as sheet metal, and may be formed via any suitable process, such as cutting, bending, welding, and so forth. In addition, the filter compartment 364 may be configured to define an internal space separate from an internal space associated with the fan housing 264. As such, the filter compartment 364 (and any components housing therein), may not decrease a volume available for the air flow within the fan filter assembly 160, thus increasing efficiency of the fan filter assembly 160. Furthermore, the filter compartment 364 may be coupled to and extend from an external surface of the main panel 268, thus the filter compartment 364 (and any components housing therein) may be easily accessed and/or serviced (e.g., without removing other components of the fan filter assembly 160). The filter compartment 364 is further described below with reference to FIG. 7.

As in the illustrated embodiment, the main panel 268, and thus the compartments (e.g., the one or more compartments 356, filter compartment 364) are positioned opposite of the filter rack assembly 266, with respect to the longitudinal axis 250 and/or an interior volume (e.g., space) of the fan housing 264. As such, the compartments (e.g., the one or more compartments 356, filter compartment 364) are configured to couple to a first external side 380 (e.g., exterior side) of the fan housing 264, and the filter rack assembly 266 is configured to couple to a second external side 382 of the fan housing 264 opposite that of the compartments (e.g., the one or more compartments 356, filter compartment 364).

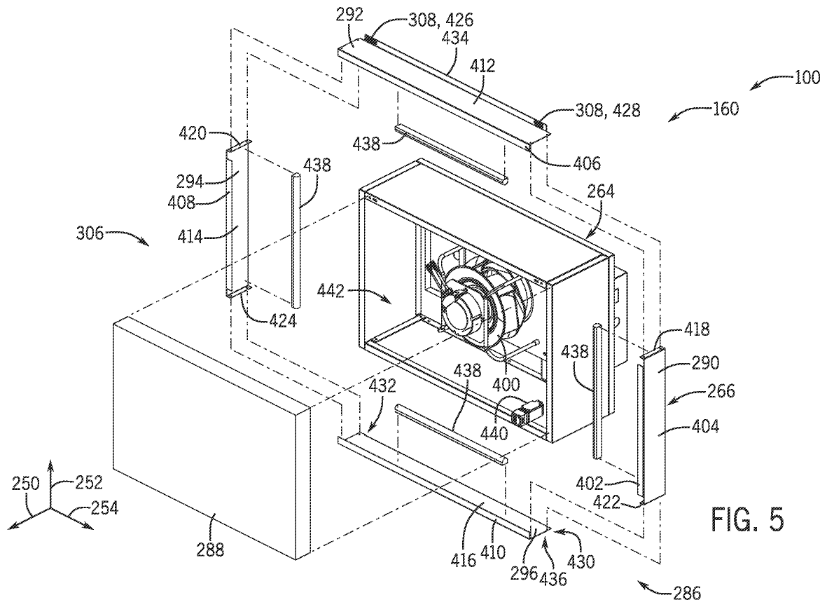

FIG. 5 is a partially exploded perspective view of an embodiment of the filter rack assembly 266 of the fan filter assembly 160, in accordance with an aspect of the present disclosure. As discussed herein, the fan filter assembly 160 includes the housing 256 configured to contain fan and/or filtering components. In addition, the housing 256 includes the fan housing 264 coupled to the filter rack assembly 266. In particular, the fan housing 264 includes (e.g., defines) an opening 442, and the filter rack assembly 266 may be positioned adjacent to the opening 442 and/or be coupled (e.g., removably couple) to the fan housing 264 such that the filter rack assembly 266 covers (e.g., conceals, overlaps, encloses) the opening 442 and/or encloses the fan housing 264. That is, the filter rack assembly 266 may be coupled to the fan housing 264 adjacent to the opening 442. Removal of the filter rack assembly 266 may expose the opening 442 and enable access to and/or removal of components (e.g., fan 400, filter, 288, control and/or electrical components within the compartments) housed within the fan filter assembly 160.

As discussed above, the filter rack assembly 266 may include the filter frame 286 and the filter 288. Furthermore, the filter frame 286 is configured to retain (e.g., support) the filter 288 in a desired position (e.g., relative to the fan housing 264). In particular, the filter frame 286 is formed from a plurality of frame panels. The filter frame 286 of FIG. 5 includes similar components and features as described in FIGS. 3 and 4. Furthermore, the first, second, third, and fourth frame panels 290, 292, 294, 296 may each be configured to support at least a portion of the filter 288. For example, as illustrated, the first, second, third, and fourth frame panels 290, 292, 294, 296 each include a respective first flange 402, 406, 408, 410 configured to extend generally cross-wise to a respective main body 404, 412, 416, 418 of the first, second, third, and fourth frame panels 290, 292, 294, 296. As such, each of the respective first flange 402, 406, 408, 410 is configured to overlap a portion of the filter 288 (e.g., when the filter 288 is installed). Therefore, the first, second, third, fourth frame panels 290, 292, 294, 296 (e.g., the respective first flanges 402, 406, 408, 410) may each be configured to position the filter 288 to extended across the discharge opening 306 (e.g., the entire discharge opening 306) of the fan filter assembly 160. In addition, when the fan filter assembly 160 is installed in a vertical position (e.g., the filter 288 is directed downwards, with respect to the vertical axis 252), the first, second, third, and fourth frame panels 290, 292, 294, 296 (e.g., the respective first flanges 402, 406, 408, 410) may each be configured to support a portion of the weight of the filter 288.

As discussed herein, each of the frame panels 290, 292, 294, 296 are coupled to two adjacent frame panels. For example, the second frame panel 292 is coupled to the first frame panel 290 and the third frame panel 294. In particular, the first and third frame panels 290, 294 each include a respective second flange 418, 420 and a respective third flange 422, 424. The respective second and third flanges 418, 420 and 422, 424 each extend generally cross-wise to the main bodies 404, 414 of the respective first and third frame panels 290, 294. In addition, the second and third flanges 418, 422 of the first frame panel 290 enable the first frame panel 290 to be coupled to the second and fourth frame panels 292, 296, while the second and third flanges 420, 424 of the third frame panel 294 enable the third frame panel 294 to be coupled to the second and fourth frame panels 292, 296.

As described in further detail below with respect to FIGS. 8-10, the filter rack assembly 266 is coupled to the fan housing 264, such that the filter rack assembly 266, and thus the filter 288, may be more readily accessed (e.g., for maintenance activity, filter removal/replacement, cleaning, etc.). In addition, easy removal and/or detachment of the filter rack assembly 266 from the fan housing 264 may enable more efficient access to one or more other components of the fan filter assembly 160, such as fan 400. As illustrated, the filter rack assembly 266 is configured to be coupled to the fan housing 264 via one or more latch assemblies 308. In particular, a portion of the latch assemblies 308 is coupled to the filter frame 286. Further, the fan filter assembly 160 may include a first latch assembly 426 and a second latch assembly 428, a respective portion of each being coupled to the second frame panel 292. Additionally, the fan filter assembly 160 may include a third latch assembly 430 and a fourth latch assembly 432, a respective portion of each being coupled to the fourth frame panel 296. In particular, each of the second and fourth frame panels 292, 296 includes a respective second flange 434, 436 extending generally cross-wise to the main bodies 412, 416 of the respective second and fourth frame panel 292, 296. Each of the second flanges 434, 436 of the respective second and fourth frame panel 292, 296 may extend along a direction generally parallel to the vertical axis, but opposite of a direction of extension associated with the first flanges 406, 410 of the respective second and fourth frame panel 292, 296. In addition, the second flange 434 of the second frame panel 292 includes at least a portion of the first and second latch assemblies 426, 428, and the second flange 436 of the fourth frame panel 296 includes at least a portion of the third and fourth latch assemblies 430, 432.

In some embodiments, the fan filter assembly 160 may include one or more light modules 438. In particular, as illustrated, the light modules 438 may be coupled to the frame panels 290, 292, 294, 296 of the filter rack assembly 266. The light modules 438 may be positioned perpendicular to a direction of an air flow through the fan filter assembly 160. The light modules 438 may include ultraviolet lights (e.g., UV, UV-C, LED UV) and/or non-UV lights (e.g., LED service lights). In embodiments including UV light modules, the UV light may enable purification of an air flow through the fan filter assembly 160 (e.g., when the air flow is exposed to the UV light). In addition, in some embodiments, the fan filter assembly 160 may include an electrical coupling assembly 440 (e.g., automatic electrical disconnects, safety switches, electrical contacts) configured to operate the light modules 438 based on a position of the filter rack assembly 266. For example, when the filter rack assembly 266 is decoupled (e.g., removed, via the latch assemblies 308) from the fan housing 264, the electrical coupling assembly 440 may cause the light modules 438 to turn off. The electrical coupling assembly 440 may operate mechanically (e.g., a switch, connection), such that manually decoupling the filter rack assembly 266 mechanically opens and/or disconnects a power connection to the light modules 438. In some embodiments, the electrical coupling assembly 440 may include a sensor (e.g., a pressure sensor, a proximity sensor, a motion sensor) configured to detect a position of the filter rack assembly 266. For example, the sensor may detect that the filter rack assembly 266 is decoupled (e.g., being decoupled) from the fan housing 264. In such embodiments, the sensor may transmit an indication to a controller (e.g., the controller 130) that the filter rack assembly 266 is decoupled from the fan housing 264, and the controller may adjust an operation of the light modules 438 based on the indication (e.g., turn off, turn on, dim, adjust brightness, etc.)

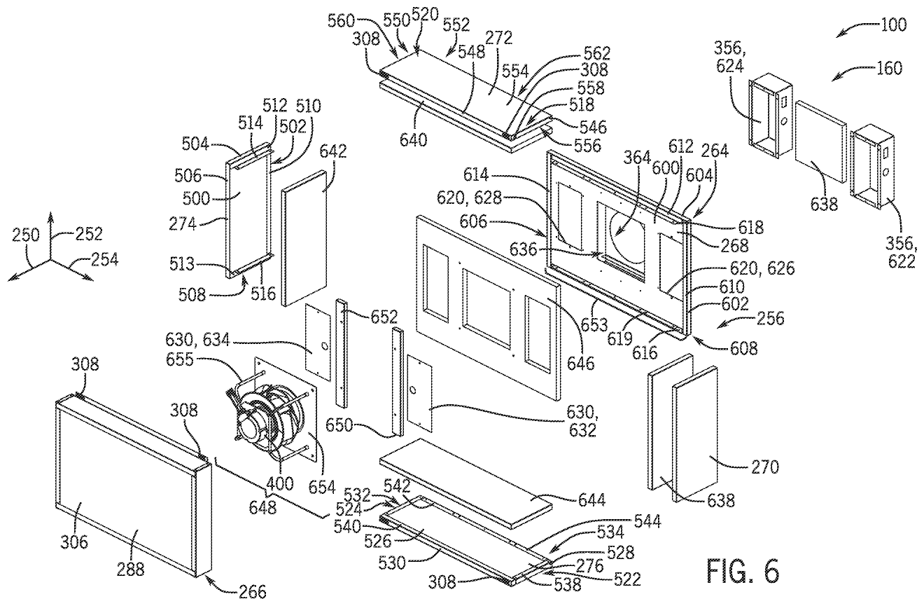

FIG. 6 is an exploded perspective view of an embodiment of the fan housing 264 of the fan filter assembly 160, in accordance with an aspect of the present disclosure. The fan housing 264 of FIG. 6 includes similar components and features as those described with reference to FIGS. 3 and 4. As discussed herein, each of the side panels 270, 272, 274, 276 are coupled to two adjacent side panels. For example, the second side panel 272 is coupled to the first side panel 270 and the third side panel 274. In particular, the third side panel 274 may include a main body 500, and a first, second, third, and fourth side wall 502, 504, 506, 508 each coupled to the main body 500, and extending generally cross-wise to the main body 500. Furthermore, the third side panel 274 includes a first, second, and third edge 510, 512, 513 each extending generally cross-wise from the respective first, second, and fourth side wall 502, 504, 508. As such, each of the first, second, and third edge 510, 512, 513 is generally parallel to the main body 500. Furthermore, the second edge 512 has a first edge flange 514 and the third edge 513 has a second edge flange 516, each of the first and second edge flanges 514, 516 extending generally cross-wise to the respective second and third edge 512, 513 (e.g., to the main body 500). The first edge flange 514 is configured to couple (e.g., via one or more fasteners, screws, bolts) to the second side panel 272 (e.g., a respective edge of the second side panel 272), and the second edge flange 516 is configured to couple to the fourth side panel 276 (e.g., a respective edge of the fourth side panel 276).

The first side panel 270 contains similar components as described for the third side panel 274. For example, a first edge flange of the first side panel 270 is configured to couple to the second side panel 272 (e.g., a respective edge of the second side panel 272), and a second edge flange of the first side panel 270 is configured to couple to the fourth side panel 276. In particular, the first side panel 270 may couple to the second side panel 272 at a first end 518 of the second side panel 272 opposite a second end 520 of the second side panel 272 at which the third side panel 274 couples to the second side panel 272. In addition, the first side panel 270 may couple to the fourth side panel 276 at a first end 522 of the fourth side panel 276 opposite of a second end 524 of the fourth side panel 276 at which the third side panel 274 couples to the fourth side panel 276.

Continuing with FIG. 6, the second and fourth side panels 272, 276 each are of a similar design with respect to each other. However, the second and fourth side panels 272, 276 are of a different design when compared to the first and third side panels 270, 274. For example, the fourth side panel 276 may include a main body 526, and a first, second, third, and fourth side wall 528, 530, 532, 534 each coupled to the main body 526, and extending generally cross-wise to the main body 526. Furthermore, the fourth side panel 276 includes a first, second, third, and fourth edge 538, 540, 542, 544, each extending approximately orthogonal from the respective first, second, third, and fourth side wall 528, 530, 532, 534. As such, each of the first, second, third, and fourth edge 538, 540, 542, 544 is generally parallel to the main body 526. Furthermore, the first edge 538 is configured to couple (e.g., via one or more fasteners, bolts, screws, etc.) to a respective edge flange of the first side wall 270, and the third edge 542 is configured to couple to the second edge flange 516 of the third side wall 274. In addition, as further described below with reference to FIGS. 8-10, the second side wall 530 includes a portion of at least one latch assembly 308. As such, the second side wall 530 is configured to couple to and support (e.g., when the fan filter assembly 160 is installed such that an air flow discharged from the fan filter assembly 160 is directed generally downwards, with respect to the vertical axis 252) at least a portion of the filter rack assembly 266. Furthermore, as further described below, the fourth edge 544 of the fourth side panel 276 is configured to couple (e.g., via one or more fasteners, screws, bolts) to the main panel 268.

The second side panel 272 contains similar components as described for the fourth side panel 276. For example, the second side panel 272 includes a first, second, third, and fourth side wall 546, 548, 550, 552 each coupled to a main body 554 of the second side panel 272, and extending generally cross-wise to the main body 554. Furthermore, the second side panel 272 includes a first, second, third, and fourth edge 556, 558, 560, 562, each extending generally cross-wise from the respective first, second, third, and fourth side wall 546, 548, 550, 552. As such, each of the first, second, third, and fourth edge 556, 558, 560, 562 is generally parallel to the main body 554. Furthermore, the first edge 556 is configured to couple (e.g., via one or more fasteners, bolts, screws, etc.) to a respective edge flange of the first side wall 270, and the third edge 560 is configured to couple to the first edge flange 514 of the third side wall 274. In addition, as further described below with reference to FIGS. 8-10, the second side wall 548 includes a portion of at least one latch assembly 308. As such, the second side wall 548 is configured to couple to and support (e.g., when the fan filter assembly 160 is installed such that an air flow discharged from the fan filter assembly 160 is directed generally downwards, with respect to the vertical axis 252) at least a portion of the filter rack assembly 266. Furthermore, as further described below, the fourth edge 562 of the second side panel 272 is configured to couple (e.g., via one or more fasteners, screws, bolts) to the main panel 268.

Moreover, the fan housing 264 may include the main panel 268. In particular, in some embodiments, the main panel 268 may enable the fan filter assembly 160 to be installed in a generally vertical position, with respect to the vertical axis 252. For example, the main panel 268 may be coupled to and/or extend from (e.g., offset a distance from, via one or more rods) a ceiling of a conditioned space (e.g., room, building, indoor space). In some embodiments, the fan filter assembly 160 may be installed such that the discharge opening 306 (e.g., the filter 288, the filter frame 286) is generally flush with a ceiling (e.g., a drop ceiling) of the conditioned space. In such instances, the fan filter assembly 160 may be oriented such that the discharge opening 306 is directed generally cross-wise to the vertical axis 252. In addition, the fan filter assembly 160 may be configured to receive an air flow from a plenum (e.g., plenum space within a drop ceiling) of the conditioned space and direct the air flow to the conditioned space.

In alternative embodiments, the fan filter assembly 160 may be installed, via the main panel 268, on and/or partially within a wall. In particular, the main panel 268 may be coupled to and/or extend from a wall of a conditioned space. In such instances, the fan filter assembly 160 may be oriented such that the discharge opening 306 is directed generally parallel to the vertical axis 252 (e.g., in a generally horizontal position). It should be understood that the fan filter assembly 160 may be installed in any suitable position, such that the fan filter assembly may be configured to filter an air flow and discharge the filtered air flow into a conditioned space.

The main panel 268 may include a main body 600, and a first, second, third, and fourth side wall 602, 604, 606, 608 each coupled to the main body 600, and extending generally cross-wise to the main body 600. In addition, the main body 600 includes a first, second, third, and fourth edge 610, 612, 614, 616, each extending generally cross-wise from the respective first, second, third, and fourth side wall 602, 604, 606, 608. As such, each of the first, second, third, and fourth edge 610, 612, 614, 616 are generally parallel to the main body 600. Furthermore, the second edge 612 has a first edge flange 618 and the fourth edge 616 has a second edge flange 619 each extending generally cross-wise to the respective second and fourth edge 612, 616 (e.g., also the main body 600). The first edge flange 618 is configured to couple (e.g., via one or more fasteners, screws, bolts) to the fourth side wall 552 of the second side panel 272, and the second edge flange 619 is configured to couple to the fourth side wall 534 of the fourth side panel 276.

In addition, as discussed herein, the fan filter assembly 160 may include the one or more compartments 356 coupled to and extending from the main panel 268. In addition, the main panel 268 may include one or more openings 620 (e.g., holes) that correspond with an installed position of the one or more compartments 356. For example, in the illustrated embodiments, the fan filter assembly 160 includes a first compartment 622 and a second compartment 624, each coupled to the main panel 268. In addition, the main panel 268 includes a first opening 626 that corresponds with the first compartment 622. In particular, the size and geometry of the first opening 626 may correspond with (e.g., be approximately equal to) a cross-sectional size (taken along the vertical axis 252) of the first compartment 624. Similarly, the main panel 268 includes a second opening 628 that corresponds with the second compartment 624. In particular, the size and geometry of the second opening 628 may correspond with (e.g., be approximately equal to) a cross-sectional size (taken along the vertical axis 252) of the second compartment 624. To this end, any suitable control and/or electrical components that may be housed within the first and/or second compartment 622, 624 may be readily accessed from within the fan housing 264 (e.g., without removal of the first and/or second compartments 622, 624 from the main panel 268).

In some embodiments, the fan housing 264 may include one or more cover plates 630, each configured to cover a respective opening 620 and/or enclose (e.g., at least partially enclose) a respective compartment 356. In particular, as in the illustrated embodiment, the fan housing 264 includes a first cover plate 632 configured to cover the first opening 626 and a second cover plate 634 configured to cover the second opening 628. The one or more cover plates 630 may configured to be readily removed to enable efficient access to an internal space of the respective compartment, and the internal components, such as control and/or electrical components, housed within the compartment. In the illustrated embodiment, the first and second cover plates 632, 634 are larger in size than a size of the corresponding first and second opening 626, 628, such that the first and second cover plates 632, 634 may be coupled (e.g., via one or more fasteners, screws, bolts) to the main panel 268.

In addition, as discussed herein, the fan filter assembly 160 may include the filter compartment 364 coupled to (e.g., via one or more fasteners, bolts, screws, etc.) and extending from the main panel 268. The main panel 268 may include a filter compartment opening 636 (e.g., hole) that correspond with an installed position of the filter compartment 364. In particular, the size and geometry of the filter compartment opening 636 may correspond with (e.g., be approximately equal to) a cross-sectional size (taken along the vertical axis 252) of the filter compartment 364. In other words, the filter compartment 364 may be adjacent to the filter compartment opening 636. The filter compartment opening 363 may enable an air flow to flow in a direction from the filter compartment 364 to an internal space within the fan housing 264. In particular, as further discussed below, a fan of the fan filter assembly 160 may direct (e.g., draw) an air flow into the fan filter assembly 160, and the air flow may flow along a flow path through the fan filter assembly 160 (e.g., flow path 258 of FIGS. 3 and 4). In particular, an air flow may traverse the filter 368, enter the filter compartment 364, traverse the filter compartment opening 636, traverse the filter 288, and exit the fan filter assembly 160 via the discharge opening 306.

It should be appreciated that in some embodiments, each of the main panel 268, the first, second, third, and fourth side panels 270, 272, 274, 276 of the fan housing 264 may be separate pieces or formed from a single piece. In particular, the main panel 268, the first, second, third, and fourth side panels 270, 272, 274, 276 may be formed from any suitable material, such as sheet metal, and may be formed via any suitable process, such as cutting, bending, welding, and so forth. In addition, each of the main panel 268, the first, second, third, and fourth side panels 270, 272, 274, 276 may define a respective internal space configured to accommodate (e.g., house, hold) a respective insulation panel (e.g., foil insulation panel). In some embodiments, the insulation panels may be configured to acoustically insulate the fan filter assembly 160. For example, the insulation panels may provide a sound barrier to reduce (e.g., dampen) an amount of noise transmission from the fan filter assembly 160. Additionally or alternatively, the insulation panels may provide increased light reflectivity within the internal space of the fan housing 264. For example, in embodiments including UV light modules, the insulation panels may increase reflectivity of light produced by the UV light modules. As such, the insulation panels may increase efficiency associated with purification of an air flow of the fan filter assembly 160.

In the illustrated embodiment, the fan filter assembly 160 includes a first, second, third, fourth, and fifth insulation panel 638, 640, 642, 644, 646. The first insulation panel 638 may be associated with the first side panel 270, the second insulation panel 640 may be associated with the second side panel 272, the third insulation panel 642 may be associated with the third side panel 274, and the fourth insulation panel 642 may be associated with the fourth side panel 276. In addition, the fifth insulation panel 646 may be associated with the main panel 268. Each of the first, second, third, fourth, and fifth insulation panel 638, 640, 642, 644, 646 may be of similar size and geometry as that of the respective associated side panel or main panel. In addition, each of the first, second, third, fourth, and fifth insulation panel 638, 640, 642, 644, 646 may be configured to fit within the respective edges (e.g., internal space defined by the edges) of the associated side panel or main panel. As an example, in the illustrated embodiment, the fifth insulation panel 646 is configured to be positioned after the first, second, third, and fourth edges 610, 612, 614, 616 of the main panel 268, with respect to the longitudinal axis 250. In addition, the fifth insulation panel 646, during operation, is configured to be positioned before the main body 600 of the main panel 268, with respect to the longitudinal axis 250. To this end, the fifth insulation panel 646 is configured to be between the first, second, third, and fourth edges 610, 612, 614, 616 of the main panel 268 and the main body 600 of the main panel 268. The first, second, third, and fourth insulation panel 638, 640, 642, 644 are configured to be installed in a similar way within the respective associated first, second, third, and fourth side panels 270, 272, 274, 276.

Continuing with FIG. 6, the fan filter assembly 160 includes a fan 400 (e.g., a backwards inclined (BI) fan, high efficiency BI fan) disposed within an internal space (e.g., internal volume) of the fan housing 264. Furthermore, the fan 400 is configured to draw (e.g., continuously draw) an air flow into the fan filter assembly 160 and direct the air flow through one or more filters of the fan filter assembly 160 to filter (e.g., clean, purify) the air flow. In addition, the fan 400 is configured to direct the air flow (e.g., filtered air flow) toward a conditioned space. For example, the fan 400 may comprise a backwards inclined (BI) fan that includes backwards inclined fan blades, with respect to a radius of the fan 400. Furthermore, the BI fan may be configured to direct an air flow in a radial direction from a center of the fan 400. In addition, the BI fan may minimize interference with the air flow as the air flow moves through the fan and/or fan blades.

The fan 400 may be a component of a fan assembly 648 that is configured to couple the fan 400 to the fan housing 264. In particular, the fan assembly 648 may enable the fan 400 to be readily removed from the fan housing 264 and/or enable the fan 400 to be more efficiently re-installed into the fan housing 264. In addition, components of the fan assembly 648 may support the fan 400 and reduce vibrations produced by the fan 400 during operation of the fan filter assembly 160. As illustrated, the fan assembly 648 includes the fan 400, a first fan support member 650 (e.g., strut, bar, stiffener, beam, rod) and second fan support member 652. The first and second fan support members 650, 652 may each be positioned generally cross-wise to a length 653 of the main panel 268. The fan 400 may be coupled (e.g., via one or more fasteners, bolts, screws, etc.) to the first and second fan support members 650, 652. In particular, the fan 400 may be coupled to a support panel 654 via one or more fan frames 655 (e.g., arresters), and the support panel 654 may be coupled to the first and second fan support members 650, 652. The one or more fan frames 655 extend from the support plate 654 and are configured to retain the fan 400 and may dampen vibrations produced by the fan 400 during operation. Moreover, the one or more fan frames 655 may support (e.g., contain, secure, couple) the fan 400 in a desired position within the fan housing 264 and/or secure the fan 400 to the support panel 654 while minimizing impedance to an air flow being drawn into the fan filter assembly 160 via the fan 400. In addition, the one or more fan frames 655 may be readily removed and enable access to the fan 400 and/or components of the fan 400 (e.g., blades, impeller, shafts, bearings, etc.).

In addition, the first and second fan support members 650, 652 may be coupled to the main panel 268. In particular, the first and second fan support members 650, 652 are coupled to the first and second edge flange 618, 619 of the main panel 268. As such, the fan 400 may be coupled to (e.g., removably coupled to, supported by) the main panel 268, via the first and second fan support members 650, 652. In some embodiments, the first and second fan support members 650, 652 may include one or more weld studs configured to extend through the support panel 654 of the fan 400 (e.g., via one or more holes in the support panel 654), enabling the fan 400 to be coupled to the first and second fan support members 650, 652. In addition, the fan 400 may be readily removed from the fan housing 264 by removing one or more bolts (e.g., via rotation of the bolts) fitted onto the one or more weld studs. Removal of the bolts may release the support panel 654, and thus the fan 400, from the first and second fan support members 650, 652. Furthermore, the fan 400 may be more efficiently re-installed or replaced (e.g., via rotation of the bolts) onto the one or more weld studs. For example, the one or more holes in the support panel 654 of the fan 400 may be configured to align with the one or more weld studs, and the fan 400 may be positioned such that the weld studs may extend through the one or more holes. The bolts may then be fitted and tightened onto the weld studs, such that the fan 400 is coupled (e.g., secured) to the first and second fan support members 650, 652. In addition, the first and second fan support members 650, 652 may be configured to reduce vibrations caused by the fan 400 during operation. In particular, the first and second fan support members 650, 652 may be composed of any suitable material and thickness of material to reduce vibrations produced by the fan 400. For example, the first and second fan support members 650, 652 may be configured to absorb, resist, and/or dampen the vibrations.

FIG. 7 is a partially exploded perspective view of an embodiment of the filter compartment 364 of the fan filter assembly 160, in accordance with an aspect of the present disclosure. The filter compartment 364 of FIG. 7 may include similar components and features as described with reference to FIG. 4. Furthermore, each of the two side portions 372 include a respective filter flange 700 extending towards a center axis 702 and parallel to the main panel 268. In the illustrated embodiment, the center axis 702 is generally parallel to the longitudinal axis 250. In particular, the first side portion 374 includes a first filter flange 704, and the second side portion 375 includes a second filter flange 706. Each of the first and second filter flanges 704, 706 is configured to support at least a portion of the filter 368 within the filter compartment 364 while reducing obstruction of an air flow path 708 (extending generally parallel to the longitudinal axis 250). For example, during operation the filter 368 may be positioned between the inlet portion 370 and the first and second filter flanges 704, 706. Furthermore, the filter 368 may extend across and occupy an area (e.g., an entire area) of the intake opening 371. In this way, an entering air flow (e.g., air flow 260 of FIGS. 3 and 4) is directed through the filter 368, and the air flow is filtered by the filter 368 before entering an internal space associated with the fan filter assembly 160 (e.g., the fan housing 264).

FIG. 8 is an exploded perspective view of an embodiment of a latch assembly 308 of the fan filter assembly 160 of an HVAC system 100, in accordance with an aspect of the present disclosure. As discussed herein, the fan filter assembly 160 may include one or more latch assemblies 308, such as the latch assembly 308 illustrated in FIG. 8, configured to couple the filter rack assembly 266 to the fan housing 264. In addition, the latch assemblies 308 may enable more efficient removal of the filter rack assembly 266 from and reinstallation of the filter rack assembly 266 to the fan housing 264. As such, the filter rack assembly 266 may be efficiently accessed and the filter 288 of the fan filter assembly 160 may be readily removed from the filter rack assembly 266 and/or replaced (e.g., during cleaning and/or maintenance activities). In addition, as further discussed herein, removal of the filter rack assembly 266 may enable more efficient access to internal components of the fan filter assembly 160, such as a fan.

As in the illustrated embodiments of FIGS. 5 and 6, the fan filter assembly 160 includes four latch assemblies 308, a first, second, third, and fourth latch assembly 426, 428, 430, 432. A respective portion of each of the first and a second latch assembly 426, 428 are coupled to the second frame panel 292 (FIG. 5) of the filter rack assembly 266, and the second side panel 272 (FIG. 6) of the fan housing 264. Furthermore, a respective portion of each of the third and fourth latch assembly 430, 432 are coupled to the fourth frame panel 296 (FIG. 5) and the fourth side panel 276 (FIG. 6).

Continuing with FIG. 8, each of the latch assemblies 308 includes a respective latch pin 750 (e.g., post, latch post), a latch base 752 (e.g., bracket, plate), and a latch fastener 754 (e.g., clip, clasp, catch). The latch pin 750 is configured to extend through and couple to a respective second side wall of the second and/or fourth side panel 272, 276 of the fan housing 264 (e.g., the second side wall 530 of the fourth side panel 276, the second side wall 548 of the second side panel 272). In particular, the latch pin 750 may extend outwardly from and/or generally cross-wise to the respective side wall. In addition, the latch pin 750 is configured to extend through a respective second flange of the second and/or fourth frame panel 292, 296 of the filter rack assembly 266 (e.g., the second flange 434 of the second frame panel 292, the second flange 436 of the fourth frame panel 296). In particular, the latch pin 750 may include a first portion 756 and a second portion 758. The first portion 756 of the latch pin 750 may extend through a respective opening 760 (e.g., aperture) of the respective second side wall and be fixedly coupled to the respective second side wall. The second portion 758 of the latch pin 750 may be separate from (e.g., separated a distance away from) the respective second side wall. In addition, the first portion 756 has a diameter that is less than a diameter of the second portion 758. Furthermore, the respective opening 760 has a diameter that is less than the diameter of the second portion 758, and greater than the diameter of the first portion 756. During operation, the first portion 756 may also extend through a respective opening 762 (e.g., aperture) of the respective second flange. In particular, the respective opening 762 has a diameter that is greater than the diameter of the second portion 758. As such, during operation, the respective second flange of the filter rack assembly 266 may be moveably coupled to the respective second side wall of the fan housing 264, via the latch pin 750.

Furthermore, each of the latch assemblies 308 includes the latch base 752. The latch base 752 is configured to be coupled to (e.g., fixedly coupled to, via one or more fasteners, screws, bolts) the respective second flange of the filter rack assembly 266 (e.g., the second flange 434 of the second frame panel 292, the second flange 436 of the fourth frame panel 296). In addition, the latch base 752 includes an opening 764. During operation, the latch pin 750 (e.g., the first portion 756) is configured to extend through the opening 764, such that the second portion 758 is separate from (e.g., separated a distance away from) the respective latch base 752, with respect to the longitudinal axis 250. The opening 764 has a diameter that is greater than the diameter of the second portion 758 and the opening 762. The latch base 752 includes a bracket portion 766 configured to couple to the latch fastener 754. In particular, the bracket portion 766 may define a channel through which the latch fastener 754 may actuate (e.g., translate, slide).

In addition, each of the latch assemblies 308 includes the latch fastener 754 configured to couple to the latch pin 750. In particular, the latch fastener 754 may include a clasp portion 768 at a first distal end of the latch fastener 754, with respect to the lateral axis 254, and a flange portion 770 (e.g., handle, extension) at a second distal end of the latch fastener 754 (e.g., opposite the first end), with respect to the lateral axis 254. The flange portion 770 may extend generally cross-wise to the respective second flange of the filter rack assembly 266. In addition, the flange portion 770 may enable a force to be applied to the latch fastener 754 to actuate (e.g. slide, translate) the latch fastener 754 relative to the latch base 752 (e.g., the fan filter assembly 160). The clasp portion 768 is configured to couple to (e.g., clip to) the latch pin 750. The latch fastener 754 may be translated in a first direction 774 and/or a second direction 776. The first and second directions 774, 776 may be generally parallel to the lateral axis 254. For example, a force applied to the latch fastener 754 (e.g., via the flange portion 770) in the first direction 774 may cause the latch fastener 754 to translate in the first direction 774 and cause a notch 772 of the clasp portion 768 to couple to the latch pin 750. On the other hand, a force applied to the latch fastener 754 (e.g., via the flange portion 770) in the second direction 776 may cause the latch fastener 754 to translate in the second direction 776 and cause the notch 772 to decouple from the latch pin 750. In this way, decoupling the latch fastener 754 from the latch pin 750 may enable the filter rack assembly 266 to be decoupled from the fan housing 264, because the respective diameters of openings 762 and 764 are greater than the diameter of the second portion 758 of the latch pin 750. Moreover, decoupling of the filter rack assembly 266 from and/or coupling the filter rack assembly 266 to the fan housing 264 may not require tools, as a force may be applied to the respective flange portions 770 of the latch assemblies 308 to cause the decoupling and/or coupling. Therefore, the latch assemblies 308 may improve serviceability of the fan filter assembly 160 as the filter rack assembly 266 may be more efficiently removed and the filter 368 may be readily accessed for maintenance activity (e.g., remove, inspect, replace, clean, etc.) In addition, internal components of the fan housing 264, such as the fan 400, may be readily accessed for maintenance activity via the one or more latch assemblies 308.

It should be appreciated that although the present embodiments illustrate a fan filter assembly 160 including four latch assemblies 308, other embodiments of the fan filter assembly 160 may utilize any suitable number of latch assemblies 308 to couple the filter rack assembly 266 to the fan housing 264 (e.g., 2, 3, 5, 6, 8). Further, the components of the latch assemblies 308 may be formed from any suitable material, such as sheet metal, steel, etc., and may be formed via any suitable process, such as cutting, bending, welding, and so forth.

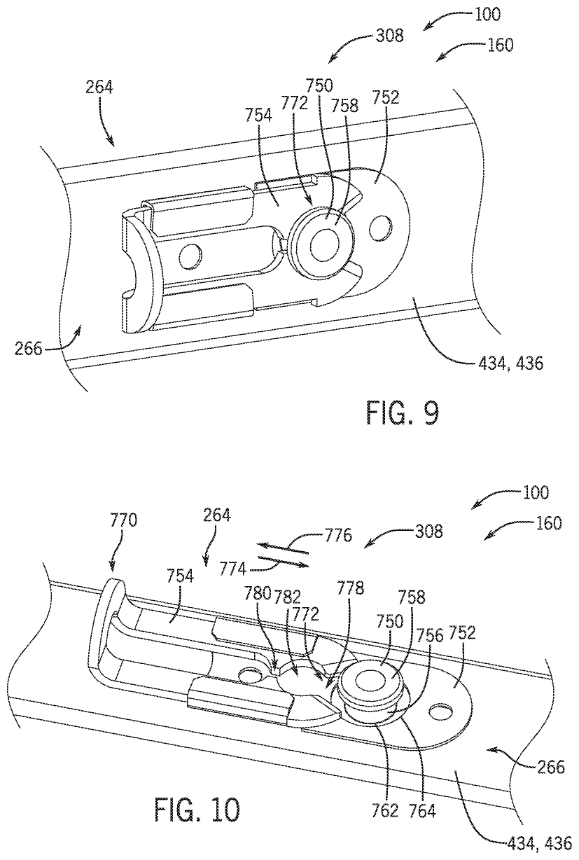

FIG. 9 is a perspective view of an embodiment of a latch assembly 308 of a fan filter assembly 160 in a retention position, in accordance with an aspect of the present disclosure. The latch assembly 308 of FIG. 9 includes similar components as those described with reference to FIG. 8. For example, the latch assembly 308 of FIG. 9 includes the latch pin 750, the latch base 752 (e.g., bracket, plate), and the latch fastener 754 (e.g., clip, clasp, catch). Furthermore, the latch assembly 308 is illustrated as coupled to a respective second flange (e.g., the second flange 434, the second flange 436) of the filter rack assembly 266. In particular, FIG. 9 illustrates the latch assembly 308 in a retention position (e.g., engaged, closed, locked, clasped, fastened, secured). In the retention position, as discussed herein, the latch assembly 308 is configured to couple the filter rack assembly 266 to the fan housing 264. Specifically, in the retention position, the notch 772 of the latch fastener 754 at least partially surrounds the first portion 756 of the latch pin 750. In this way, the latch fastener 754 is coupled to (e.g., fastened, clasped, locked, joined with) the latch pin 750, preventing the filter rack assembly 266 from decoupling (e.g., separating) from the fan housing 264. In particular, a diameter of an inner portion of the notch 772 is less than the diameter of the second portion 758 of the latch pin 750. As such, in the retention position, the latch fastener 754 prevents the respective opening 762 of the second flange 434, 436 and the respective opening 764 of the latch base 752 from translating along the latch pin 750.

FIG. 10 is a perspective view of an embodiment of a latch assembly 308 of a fan filter assembly 160 in a released position, in accordance with an aspect of the present disclosure. The latch assembly 308 of FIG. 10 includes similar components as those described with reference to FIG. 8. For example, the latch assembly 308 of FIG. 10 includes the latch pin 750, the latch base 752 (e.g., bracket, plate), and the latch fastener 754 (e.g., clip, clasp, catch). Furthermore, the latch assembly 308 is illustrated as coupled to a respective second flange (e.g., the second flange 434, the second flange 436) of the filter rack assembly 266. In particular, FIG. 10 illustrates the latch assembly 308 in the released position (e.g., open, unlocked, unclasped, unfastened, unsecured). In the released position, as discussed herein, the latch assembly 308 is configured to uncouple the filter rack assembly 266 from the fan housing 264. Specifically, in the released position, the notch 772 of the latch fastener 754 does not surround the first portion 756 of the latch pin 750. In this way, the latch fastener 754 is uncoupled from (e.g., disengaged, unfastened, unclasped, unlocked, free from) the latch pin 750, enabling the filter rack assembly 266 to decoupling from the fan housing 264. In particular, a first gap 778 of the notch 772 has a width that corresponds to (e.g., is approximately equal to or less than) the diameter of the first portion 756 of the latch pin 750. Furthermore, a second gap 780 of the notch 772 may enable the first gap 778 to increase (e.g., expand) when a force is applied to the latch fastener 754 in the first and/or second directions 774, 776. As such, the first portion 756 of the latch pin 750 may move into and out of a center opening 782 of the notch 772 (e.g., when the latch fastener 754 is translated in the first and/or second directions 774, 776. Furthermore, in the released position, the respective opening 762 of the second flange 434, 436 and the respective opening 764 of the latch base 752 may translate (e.g., freely translate) along the latch pin 750, thus decoupling the filter rack assembly 266 from the fan housing 264.

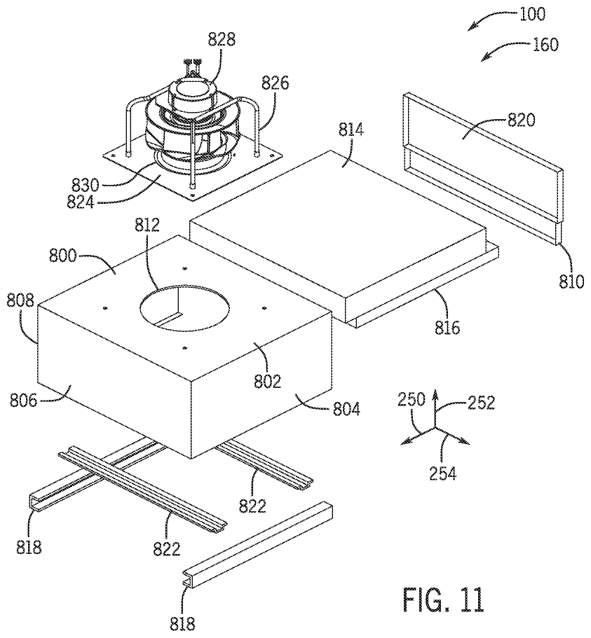

FIG. 11 is an exploded perspective view of an embodiment of the fan filter assembly 160 of the HVAC system 100, in accordance with an aspect of the present disclosure. The fan filter assembly 160 includes a housing 800 having a main panel 802 and a plurality of sides. In particular, the housing 800 includes a first, second, third, and fourth side 804, 806, 808, 810. The first, second, third, and fourth side 804, 806, 808, 810 may be separate components coupled together and/or coupled to the main panel 802 (e.g., via one or more fasteners, screws, bolts). In some embodiments, the main panel 802 and the first, second, third, and fourth side 804, 806, 808, 810 may be coupled together via a weld. Further, the main panel 802 includes an opening 812 (e.g., inlet, intake) configured to receive an air flow therethrough. In particular, the opening 812 may enable an air flow to enter an interior space of the housing 800.

The fan filter assembly 160 may include one or more filters, such as the illustrated first filter 814 and the second filter 816. The first and/or second filter 814, 816 are configured to filter (e.g., purify, clean) an air flow (e.g., the air flow entering through the opening 812). In some embodiments, the first and/or second filters 814, 816 may include a HEPA filter (e.g., fine particle filter) and a pre-filter (e.g., large particle filter). It should be appreciated that the fan filter assembly 160 may include any type of suitable filter for filtration of an air flow. In addition, the fan filter assembly 160 may include one or more brackets 818 for coupling (e.g., positioning, mounting) of the one or more filters (e.g., first and/or second filter 814, 816) within the housing 800.

The fan filter assembly 160 may include an access door 820 positioned on at least one of the first, second, third, and fourth sides 804, 806, 808, 810 of the housing 800. The access door 820 may enable increase efficiency with regards to accessing an interior of the housing 800 and/or accessing one or more components contained within the housings, such as the first and/or second filters 814, 816. As shown in the illustrated embodiment, the access door 820 is positioned on the fourth side 810. The access door 820 may have any suitable shape and/or size to facilitate installation, removal, and/or replacement of the first and/or second filters 814, 816. In particular, the shape and/or size of the access door 820 may correspond with a shape and/or size of a cross-section of the first and/or second filters 814, 816. In addition, the access door 820 may be coupled to (e.g., rotatably coupled to, via one or more hinges) the fourth side 810. In this way, the first and/or second filters 814, 816 may be readily accessed and/or serviced (e.g., without removing other components of the fan filter assembly 160), such as for maintenance activity (e.g., remove, inspect, replace, clean, etc.).

Furthermore, the fan filter assembly 160 may include one or more support members 822 coupled to (e.g., via one or more fasteners, screws, bolts) the main panel 802 of the housing 800. In some embodiments, the support members 822 are coupled to an internal surface of the main panel 802. The support members 822 may have a similar configuration, composition, and/or coupled to the main panel 802 in a similar way as that of the first and second fan support members 650, 652 coupled to the main panel 268 as described with reference to FIG. 6. The fan filter assembly 160 may include a fan support plate 824 and one or more fan frames 826. The one or more fan frames 826 (e.g., arresters) are configured to couple a fan 828 (e.g., BI fan) to the fan support plate 824. The one or more fan frames 826 extend from the support plate 824 and are configured to retain the fan 828 and dampen vibrations produced by the fan 828 during operation. The one or more fan frames 826 may be similar to the one or more fan frames 655 as described with reference to FIG. 6. Furthermore, the fan support plate 824 may have an opening 830 that corresponds with the opening 812 of the main panel 802. The fan 828 may be configured to draw and/or direct an air flow into the housing 800 of the fan filter assembly 160 (e.g., and thus across the first and/or second filters 814, 816) via the opening 830 of the fan support panel 824 and the opening 812 of the main panel 802. In addition, the fan support plate 824 is coupled (e.g., mounted) to an external surface of the main panel 802 of the housing 800. In particular, the fan support plate 824 is removably coupled to the support members 822 via one or more fasteners that extend through the main panel 268 to couple to the support members 822. In some embodiments, the fan support plate 824 may be removably coupled to the support members 822 using the same one or more fasteners that couple the support members 822 to the internal surface of the main panel 802. In some embodiments, the fasteners may include one or more weld studs. In any case, because the fan 828 is installed on the external surface of the housing 800 and is removably coupled to the housing 800, thus the fan 828 is readily accessed for maintenance activity (e.g., remove, inspect, replace, clean, etc.) of the fan 828. As such, the design of the fan filter assembly 160 may increase serviceability of the fan filter assembly 160.

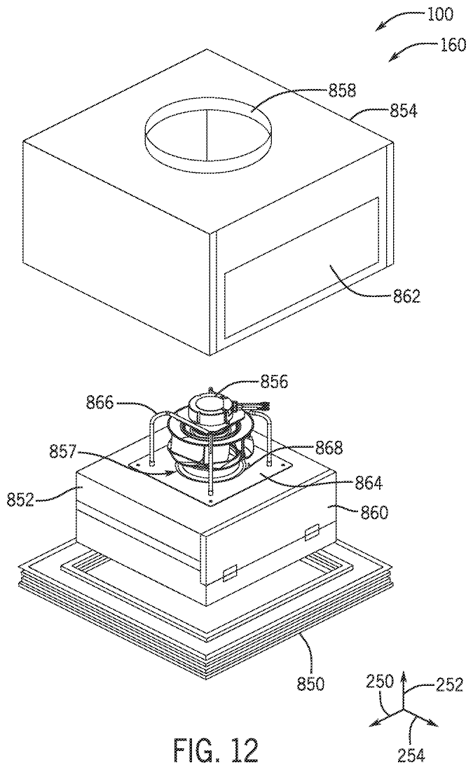

FIG. 12 is a partially exploded perspective view of an embodiment of the fan filter assembly 160 of the HVAC system 100, in accordance with an aspect of the present disclosure. The fan filter assembly 160 includes a frame 850 (e.g., modular flow frame), a filter housing 852, a casing 854, and a fan 856 (e.g., BI fan). The frame 850 may be coupled to the casing 854, such that the frame 850 and the casing 854 together define an internal space of the fan filter assembly 160, in which the filter housing 852 and the fan 856 is contained. In particular, the frame 850 may be coupled at a base of the casing 854, relative to the vertical axis 252. In addition, the fan filter assembly 160 may include one or more brackets for coupling (e.g., positioning, mounting) of the filter housing 852 within the casing 854. The frame 850 is configured to direct an air flow from the fan filter assembly 160 and into a conditioned space. In particular, the frame 850 may be a modular flow frame configured to adjust a direction of the air flow directed towards to the conditioned space. The casing 854 is configured to enclose (e.g., cover, contain) the filter housing 852 and the fan 856. Furthermore, the casing 854 may include an opening 858. The opening 858 may enable an air flow to enter (e.g., be drawn into via the fan 856, directed into via the HVAC system 100) the casing 854. In addition, the filter housing 852 may contain one or more filters, similar to the filters discussed herein. The filters are configured to filter (e.g., clean, purify) an air flow that enters the fan filter assembly 160 prior to the air flow being discharged from the fan filter assembly 160 and into a conditioned space. In particular, the filter housing 852 includes an opening 857 configured to enable an airflow to enter the filter housing 852 and be directed (e.g., via the fan 856) across the filters within the filter housing 852.

Moreover, the filter housing 852 may include an access door 860 coupled to (e.g., rotatably coupled to, via one or more hinges) the filter housing 852. The access door 860 may enable increase efficiency with regards to accessing an interior of the filter housing 852 and/or accessing one or more components contained within the filter housing 852, such as the filters. Similarly, the casing 854 may include an access panel 862 coupled to (e.g., removably coupled to) the casing 854. The access panel 862 is configured to enable ease of access to an interior of the casing 854 and/or one or more components contained within the casing 854, such as the filter housing 852 and/or the fan 856. In some embodiments, a position of the access panel 862 may correspond to (e.g., align with) a position of the access door 860 of the filter housing 852. In this way, one or more components of the fan filter assembly 160 (e.g., the filters, fan 856, etc.) may be readily accessed and/or serviced, such as for maintenance activity (e.g., remove, inspect, replace, clean, etc.).

In addition, the fan filter assembly 160 may include a fan support plate 864 and one or more fan frames 866 (e.g., arresters). The one or more fan frames 866 are configured to couple the fan 856 (e.g., BI fan) to the fan support plate 864. The one or more fan frames 866 extend from the support plate 864 and are configured to retain the fan 856 and dampen vibrations produced by the fan 856 during operation. The one or more fan frames 866 may be similar to the one or more fan frames 655 as described with reference to FIG. 6. Furthermore, the fan support plate 864 may have an opening 868 that corresponds with the opening 857 of the filter housing 852. The fan 856 may be configured to draw and/or direct an air flow into the filter housing 852 of the fan filter assembly 160 (e.g., and thus across the filters) via the opening 857 of the fan support panel 824 and the opening 868 of the filter housing 852. In addition, the fan support plate 864 is coupled (e.g., mounted) to an external surface of the filter housing 852. In particular, the fan support plate 864 is removably coupled to the filter housing 852. As such, the fan 856 is more efficiently accessed for maintenance activity (e.g., remove, inspect, replace, clean, etc.) of the fan 856. As such, the design of the fan filter assembly 160 may increase serviceability of the fan filter assembly 160.

As discussed in detail above, present embodiments are directed to an HVAC system including a fan filter assembly. The fan filter assembly may be configured to operate independently of, be retrofitted to, or be integrated with components of the HVAC system. In addition, the fan filter assembly includes a filter configured to filter an air flow directed through the fan filter assembly. In accordance with present techniques, the fan filter assembly may enable the filter to be more efficiently accessed for maintenance activity, such as removal, inspection, replacement, and/or cleaning of the filter. Furthermore, the fan filter assembly includes a fan (e.g., fan assembly) configured to circulate the air flow through fan filter assembly. Due to the design of the fan filter assembly, the fan may be efficiently accessible within a housing of the fan filter assembly. In particular, the fan is configured to couple to the housing such that the fan may be readily removed from the housing and/or reinstalled (e.g., replaced). As such, the present embodiments of the fan filter assembly may enable the HVAC system to filter (e.g., purify, clean) an air flow provided to the indoor environment to control an air quality of the air flow while improving serviceability of the fan filter assembly. The fan filter assembly may also improve air circulation of the air flow within the indoor environment. In addition, the design of the fan filter assembly may decrease a downtime of the HVAC system (e.g., the fan filter assembly) and decrease a cost associated with maintenance activity of the fan filter assembly, thus increasing efficiency of the HVAC system.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

While only certain features and embodiments of the disclosure have been illustrated and described, many modifications and changes may occur to those skilled in the art, such as variations in number, proportions, sizes, dimensions, structures, shapes and proportions of the various elements, values of parameters, including temperatures and pressures, mounting arrangements, use of materials, colors, orientations, and so forth without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure.

Furthermore, in an effort to provide a concise description of the exemplary embodiments, all features of an actual implementation may not have been described, such as those unrelated to the presently contemplated best mode of carrying out the disclosure, or those unrelated to enabling the claimed disclosure. It should be noted that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A fan filter assembly, comprising:
a main housing comprising a first opening and a second opening;
a fan configured be disposed within and removably coupled to the main housing;
a first filter housing configured to couple to the main housing adjacent to the first opening, wherein the first filter housing is configured to support a first filter; and
a second filter housing configured to removably couple to the main housing adjacent to the second opening, wherein the second filter housing is configured to support a second filter, wherein the second filter housing is removable from the main housing to enable access to the fan via the second opening.

2. The fan filter assembly of claim 1, wherein the fan is configured to draw an air flow through the first filter in the first filter housing and into the main housing via the first opening, and the fan is configured to discharge the air flow from the main housing via the second opening and direct the air flow through the second filter in the second filter housing.

3. The fan filter assembly of claim 1, wherein the first filter housing is configured to couple to a first external side of the main housing, the second filter housing is configured to removably couple to a second external side of the main housing, and the first external side and the second external side are opposite one another relative to an interior volume of the main housing.

4. The fan filter assembly of claim 1, wherein the fan filter assembly is configured to be installed at least partially within a ceiling of a conditioned space, the fan is configured to draw an air flow from a plenum space within the ceiling, across the first filter and into the main housing via the first opening, and the fan is configured to discharge the air flow from the main housing via the second opening, direct the air flow through the second filter, and direct the air flow into the conditioned space.

5. The fan filter assembly of claim 1, comprising the first filter and the second filter, wherein the first filter is a pre-filter configured to capture first particles having a first particle size, the second filter is a high efficiency particulate air (HEPA) filter configured capture second particles having a second particle size, wherein the second particle size is smaller than the first particle size.

6. The fan filter assembly of claim 1, wherein the fan comprises a backwards inclined fan.

7. The fan filter assembly of claim 1, wherein the fan filter assembly comprises a plurality of fan support members secured to the main housing, and wherein the fan is configured to removably couple to the plurality of fan support members.

8. The fan filter assembly of claim 1, wherein the fan is removable from the main housing via the second opening.

9. The fan filter assembly of claim 1, comprising a latch assembly configured to removably couple the second filter housing to the main housing.

10. The fan filter assembly of claim 9, wherein the latch assembly comprises:
a latch pin configured to extend through the second filter housing; and
a latch fastener configured to engage with the latch pin, wherein the latch fastener is configured to slide relative to the latch pin to engage and disengage the latch fastener from the latch pin.

11. The fan filter assembly of claim 10, wherein the latch pin is secured to the main housing and extends outwardly from the main housing, and the latch fastener is coupled to the second filter housing.

12. A heating, ventilation, and air conditioning (HVAC) system, comprising:
a fan filter unit configured to filter an air flow directed through the fan filter unit, wherein the fan filter unit comprises:
a housing comprising a first opening, an internal volume, and a second opening;
a fan disposed within the internal volume and configured to direct the air flow through the housing, wherein the fan is removable from the housing via the second opening; and
a filter rack assembly configured to removably mount to an exterior of the housing, wherein the filter rack assembly is configured to contain a filter, and the fan is configured to discharge the air flow from the housing via the second opening and to direct the air flow through filter.

13. The HVAC system of claim 12, wherein the filter rack assembly is configured to removably mount to the housing adjacent to the second opening.

14. The HVAC system of claim 12, wherein the fan filter unit comprises a filter housing configured to mount to the exterior of the housing adjacent to the first opening, wherein the filter housing comprises an additional filter, and the fan is configured to draw the air flow through the additional filter and into the housing via the first opening.

15. The HVAC system of claim 12, wherein the fan filter unit comprises a plurality of latch assemblies, wherein the plurality of latch assemblies is configured to removably mount the filter rack assembly to the exterior of the housing without a tool.

16. The HVAC system of claim 15, wherein each latch assembly comprises:
a post secured to the housing and configured to extend through a respective opening formed in the filter rack assembly; and
a latch coupled to the filter rack assembly, wherein the latch is slidable relative to the filter rack assembly between an engaged position and a disengaged position, and the latch is configured to capture the post in the engaged position to removably mount the filter rack assembly to the housing.

17. The HVAC system of claim 12, wherein the fan filter unit is configured be mounted to a ceiling of a conditioned space, the fan is configured to draw the air flow into the housing from a plenum within the ceiling, and the fan is configured to direct the air flow through the filter and into the conditioned space.

18. A fan filter unit of a heating, ventilation, and air conditioning (HVAC) system, comprising:
a fan housing configured to receive an air flow, wherein the fan housing defines a first opening and a second opening, and the fan housing comprises a plurality of support members;
a fan disposed within the fan housing and removably mounted to the fan housing via the plurality of support members, wherein the fan is configured to draw an air flow into the fan housing via the first opening and to discharge the air flow from the fan housing via the second opening;
a filter housing removably coupled to the fan housing adjacent to the second opening, wherein the filter housing is removable from the fan housing to expose the fan via the second opening of the housing in an installed configuration of the fan filter unit; and
a filter disposed within the filter housing and configured to filter the air flow discharged from the fan housing via the second opening.

19. The fan filter unit of claim 18, comprising a latch assembly configured to removably secure the filter housing to the fan housing, wherein the latch assembly comprises:
a latch post secured to the fan housing and configured to extend through an aperture formed in the filter housing, and
a latch fastener coupled to the filter housing and configured to engage with the latch post, wherein the latch fastener is configured to translate relative to filter housing and relative to the latch post to engage and disengage the latch fastener from the latch post.

20. The fan filter unit of claim 19, wherein the latch fastener is actuatable to engage and disengage the latch fastener from the latch post without a tool in the installed configuration of the fan filter unit.
